(19) United States
(12) Patent Application Publication
(10) Pub. No.: US 2026/0078869 A1
(43) Pub. Date: Mar. 19, 2026

(54) ADHESIVE SYSTEMS FOR GRASPING SURFACES

(71) Applicant: VIRGINIA TECH INTELLECTUAL PROPERTIES, INC., Blacksburg, VA (US)

(72) Inventors: Michael D. Bartlett, Blacksburg, VA (US); Chanhong Lee, Christiansburg, VA (US); Ravi Tej Anand Tutika, Christiansburg, VA (US)

(21) Appl. No.: 19/331,660

(22) Filed: Sep. 17, 2025

Related U.S. Application Data
(60) Provisional application No. 63/695,648, filed on Sep. 17, 2024.

(51) Int. Cl. F16M 13/02

(52) U.S. Cl. CPC F16M 13/022

(57) ABSTRACT

Various examples of switchable adhesive elements are described. An example switchable adhesive element includes a compliant stalk extending from a support end to a contact end. The compliant stalk includes a tapered outer surface and a curved contact surface at the contact end. The switchable adhesive element further includes a membrane coupled to the curved contact surface and capping the contact end of the compliant stalk. The curved contact surface can be curved with a radius of curvature between 5 mm and 100 mm in various examples. In other aspects, the compliant stalk includes a fluid channel that extends through the compliant stalk from the support end to the contact end, and the membrane is pneumatically or hydraulically actuated via the fluid channel through the compliant stalk.

### CROSS REFERENCE TO RELATED APPLICATIONS

This application claims the benefit of and priority to U.S. Provisional Application Ser. No. 63/695,648, filed Sep. 17, 2024, titled “ADHESIVE SYSTEMS FOR GRASPING SURFACES,” the entire contents of which are hereby incorporated herein by reference.

### GOVERNMENT LICENSE RIGHTS

This invention was made with government support under Grant No. 2119105 awarded by the National Science Foundation and under Grant No. HR0011-24-3-0365 awarded by the Defense Advanced Research Projects Agency (IE). The government has certain rights in the invention.

### BACKGROUND

Strong underwater attachment is a significant challenge due to the existence of a layer of water at the interface. Attachment becomes more complicated in “real-world” environments which often display irregular surfaces and challenging conditions. For example, rough or curved surfaces have reduced contact area between the attachment device and substrate, which can limit adhesion strength. The surface energy of the materials in contact is another factor that affects interaction forces, where lower surface energy materials form weaker attraction forces. Furthermore, the types of fluid at the interface affects the interaction between adhesive and surface. For example, seawater, which includes various ions, can result in lower adhesion compared to deionized water due to Debye screening and other effects. Overall, these diverse factors can reduce attachment strength and ultimately decrease the effectiveness of underwater attachment and controlled release.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the concepts of the disclosure. Moreover, repeated use of reference characters or numerals in the figures is intended to represent the same or analogous features, elements, or operations across different figures. Repeated description of such repeated reference characters or numerals is omitted for brevity.

FIGS. 1A-1C illustrate an example of a switchable, sensorized underwater adhesive system, in accordance with various embodiments of the present disclosure.

FIGS. 2A-2D illustrate an example of characterization of a switchable underwater adhesive element, in accordance with various embodiments of the present disclosure.

FIGS. 3A-3G illustrate underwater adhesion strength, toughness, and release of a switchable underwater adhesive element, in accordance with various embodiments of the present disclosure.

FIGS. 4A-4E illustrate examples of adhesion under non-ideal conditions, in accordance with various embodiments of the present disclosure.

FIGS. 5A-5I illustrate an example of adhesive skin for intelligent underwater manipulation, in accordance with various embodiments of the present disclosure.

FIG. 6A illustrates switchable adhesive cross-sections and actuation of an example membrane in activated and deactivated states in accordance with various embodiments of the present disclosure.

FIG. 6B illustrates effect of curvature examples on ability to seal interfacial pressure on an irregular surface in accordance with various embodiments of the present disclosure.

FIG. 6C illustrates example attach-and-release and underwater manipulation demonstration on irregular surfaces in accordance with various embodiments of the present disclosure.

FIG. 6D illustrates example stress versus time for an activated and deactivated switchable adhesive element during a pull-off test underwater in accordance with various embodiments of the present disclosure.

FIG. 6E illustrates example underwater attachment strength on various substrates and environmental conditions in accordance with various embodiments of the present disclosure.

FIG. 7 illustrates a cross-sectional view of another example switchable adhesive element in accordance with various embodiments of the present disclosure.

FIG. 8A illustrates example contact area photographs for different stalk curvatures and corresponding schematics showing effective stress depending on stalk curvature in accordance with various embodiments of the present disclosure.

FIG. 8B illustrates example measured underwater contact area with a 1 N preload and calculated effective contact stress in accordance with various embodiments of the present disclosure.

FIG. 8C illustrates example interfacial pressure during an attachment test on a rough, dry surface in accordance with various embodiments of the present disclosure.

FIG. 8D illustrates example underwater attachment strength in deactivated and activated states for different stalk curvature with a 1 N preload in accordance with various embodiments of the present disclosure.

FIG. 8E illustrates example preload dependence of underwater attachment strength in a deactivated state for different stalk curvatures in accordance with various embodiments of the present disclosure.

FIGS. 9A to 9E illustrate example underwater attachment strength in accordance with various embodiments of the present disclosure.

FIGS. 10A to 10F illustrates example scalable attachment strength in accordance with various embodiments of the present disclosure.

FIG. 11A illustrates a perspective view of another example switchable adhesive element in accordance with various embodiments of the present disclosure.

FIGS. 11B and 11C each illustrate an exploded perspective view of the switchable adhesive element shown in FIG. 11A in accordance with various embodiments of the present disclosure.

FIGS. 11D, 11E, and 11F illustrate different cross-sectional side views of the switchable adhesive element shown in FIG. 11A in different example states of operation in accordance with various embodiments of the present disclosure.

FIG. 12A illustrates a perspective view of another example switchable adhesive element in accordance with various embodiments of the present disclosure.

FIGS. 12B, 12C, and 12D illustrate different cross-sectional side views of the switchable adhesive element shown in FIG. 12A in different example states of operation in accordance with various embodiments of the present disclosure.

FIG. 13 illustrates a perspective view of another example switchable adhesive element in accordance with various embodiments of the present disclosure.

FIG. 14 illustrates a flow diagram of an example three-dimensional printing fabrication method in accordance with various embodiments of the present disclosure.

FIG. 15 illustrates a flow diagram of an example cast and molding fabrication method in accordance with various embodiments of the present disclosure.

FIG. 16 illustrates a flow diagram of another example cast and molding fabrication method in accordance with various embodiments of the present disclosure.

FIG. 17 illustrates a flow diagram of an example fabrication method in accordance with various embodiments of the present disclosure.

FIG. 18 illustrates a flow diagram of another example cast and molding fabrication method in accordance with various embodiments of the present disclosure.

FIG. 19 illustrates a flow diagram of another example fabrication method in accordance with various embodiments of the present disclosure.

### DETAILED DESCRIPTION

Adhesives suited for wet or underwater environments can be important for applications ranging from healthcare and underwater robotics to infrastructure repair. However, achieving strong attachment and controlled release on difficult substrates, such as those that are curved, rough, or located in diverse fluid environments, remains a major challenge. Adhesive systems with strong attachment and rapid release in challenging underwater environments are described herein. The systems utilize a compliant stalk and an active, deformable membrane for multi-surface adhesion. A curved or concavely shaped contact surface at one end of the stalk enhances conformal contact on large-scale curvatures and increases contact stress for adaptability to small-scale roughness. These synergistic mechanisms improve contact across multiple length scales, with fast switching ratios and consistent attachment strength on diverse surfaces and conditions.

Several different methods have been developed to achieve robust attachment in wet environments. For example, hydrogels, which can absorb water at the interface and contain functional groups such as amino, carboxyl, or hydroxyl groups, can create strong adhesion. Additionally, chemical modification of adhesives can promote strong bonding to the substrate through chemical reactions in a wet environment. Although hydrogels and chemical modification provide robust adhesion performance in wet environments, these approaches are often focused on permanent adhesives and are not readily released in many cases.

The switchable adhesive systems described herein can strongly attach while switching to a low force for release through a prescribed stimulus. In wet or submerged environments, switchable attachment can be achieved through several different mechanisms, including capillary forces, hydrostatics (e.g., suction), hydrodynamics, surface adhesion, another mechanism, or any combination thereof.

The switchable adhesive systems can generate strong adhesion yet can be removed on demand with a prescribed trigger and then can be reused. In these systems, a trigger, such as a mechanical, electromagnetic, fluidic, or thermal stimuli, results in a change in contact area, mechanical properties, or near interface characteristics to modulate adhesion. In active, pressure driven systems observed in cephalopods, a pressure differential between a chamber on an adhesive element and a surrounding medium can be created to generate a force used for attaching the adhesive element. The adhesive element can then be actuated again for release. This mechanism can function in dry or unsubmerged and submerged environments, allowing for attachment and release in diverse environments.

Sensing a proximity of a surface in synthetic systems that work in air and underwater can be achieved through a few different methodologies. This includes optical proximity sensors that utilize lasers or camera-based vision systems, and sound-based range sensors. However, the size of these sensor systems can limit their integration with synthetic adhesives, which limits manipulation or autonomous grasping capabilities in uncontrolled environments.

An adhesive system described herein include switchable adhesive elements coupled with a sensory system, processing, and control for autonomous adhesive activation and release in dry and wet environments. Some switchable adhesive elements can include a compliant stalk having a contact end with a circular or annular cross-section or geometry and a non-linear or curved contact surface at the contact end of the compliant stalk. For instance, the contact surface at the contact end on the compliant stalk can have an inwardly curved or concavely shaped contact surface at the contact end of the compliant stalk. In another example, the contact surface at the contact end on the compliant stalk can have an inwardly sloped or tapered contact surface at the contact end of the compliant stalk.

Some switchable adhesive elements can include a compliant stalk having one or more porous membranes coupled to a contact end of the compliant stalk. The porous membranes can be embodied with a disc or semi-disc geometry or cross-section in some cases or an annular or semi-annular geometry or cross-section in other cases. The porous membranes can be configured to absorb, store, and release various liquid adhesive materials such as one or more resins, photoresins, epoxies, glues, or other adhesive materials that can be used to temporarily or permanently secure a switchable adhesive element to different object surfaces in dry and wet environments. Some switchable adhesive elements can further include one or more liquid channels or passages formed on or through at least one of a compliant stalk or a base portion coupled to a support end of the compliant stalk. The liquid channels or passages can be formed such that they are in liquid flow communication with porous membranes coupled to a contact end of the compliant stalk to allow for controlled application of an adhesive material to an object surface by way of the liquid channels or passages and the porous membranes.

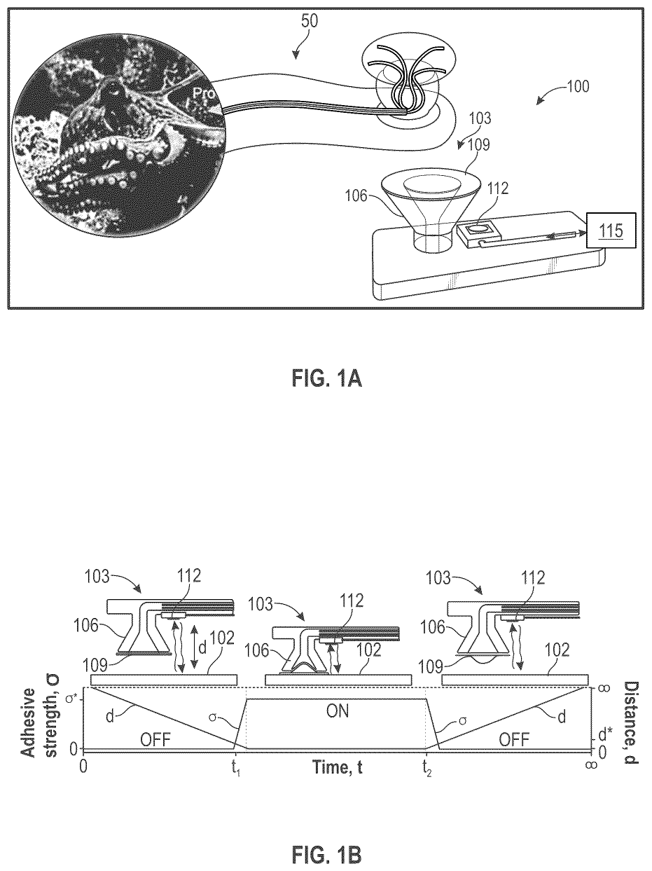

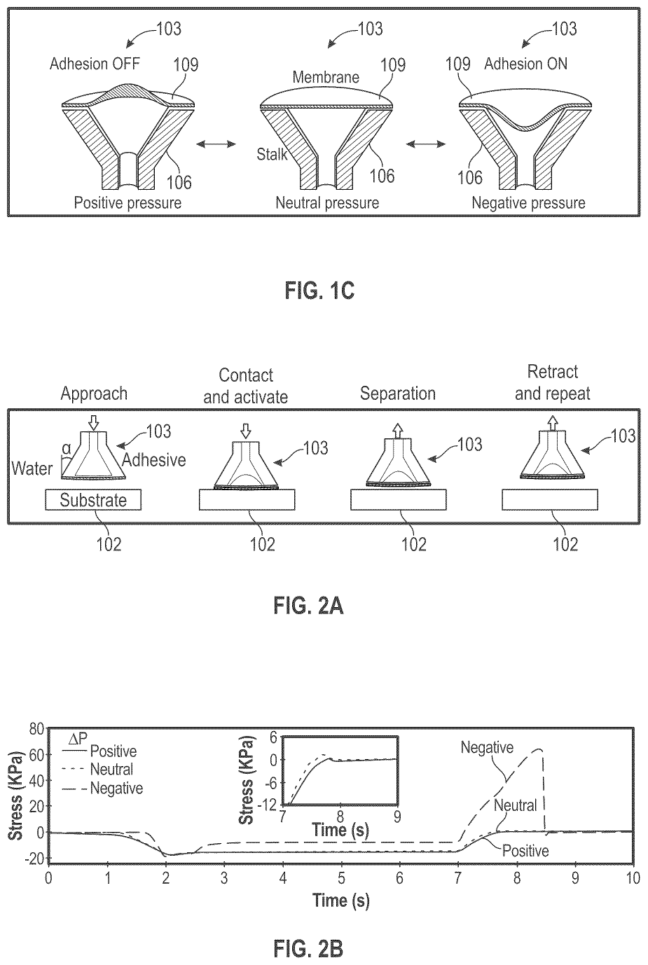

For context, FIG. 1A illustrates an example adhesive system 50 of an octopus and an example of a sensorized, octopus-inspired adhesive system 100 according to various aspects and embodiments of the present disclosure. As shown, the adhesive and sensory system 100 can be integrated with processing and control to sense objects and switch adhesion. In the example shown in FIG. 1A, the adhesive system 100 includes one or more adhesive elements 103 that each include a compliant, silicone stalk 106 capped with a soft, pneumatically or hydraulically actuated membrane 109 (or “pressure actuated membrane 109”) to control adhesion.

The adhesive elements 103 can be tightly integrated with, e.g., an array of micro-LIDAR optical proximity sensors 112 and a microcontroller 115 or other processing circuitry for real-time object detection and control of adhesion. This tightly integrated adhesive system 100 can mimic a nervous system, enabling the adhesive system 100 to intelligently control multiple adhesive elements 103 to achieve dexterous manipulation in dry and wet environments. When an object is sensed at a programmed distance (d^{¿}) the pressure actuated membrane 109 can be triggered. This enables autonomous activation of adhesion through a prescribed control loop for rapid attachment and controlled release by tuning the state of the membrane 109. FIG. 1B illustrates an example of a switchable adhesive element such as the switchable adhesive element 103 with an integrated micro-LIDAR optical sensor 112 according to various aspects and embodiments of the present disclosure. In this example the adhesion of the switchable adhesive element 103 goes from an OFF state to an ON state at time t₁ with an adhesive strength σ^{¿} once the sensor 112 is triggered at a defined distance d^{¿}. The adhesion returns to the OFF state at time t₂ to release the switchable adhesive element 103.

By applying positive pressure, the membrane 109 can be inflated for negligible adhesion. Alternatively, negative pressure can be applied to increase the volume of the adhesive element 103 at the interface, creating a suction pressure and enhancing adhesion. FIG. 1C schematically illustrates the different states of the pressure actuated membrane 109 under positive, neutral, and negative pressure which controls the adhesion from an OFF to ON state. This octopus-inspired mechanism enables adhesive stresses greater than 60 kPa underwater, with an adhesive switching ratio over 450× from the ON to OFF state. In one example illustrating underwater adhesion results from an octopus-inspired adhesive using an adhesion switching ratio of 450× from the ON to OFF state, reversibility was demonstrated over multiple cycles and rapid switching times <50 ms were achieved from a fully ON state to a released/OFF state.

By tuning adhesive element compliance through the stalk architecture, reliable attachment to off-angle substrates can be enabled with reduced preloads and with independent control of adhesive strength and work of separation providing reliable adhesion in non-ideal conditions. The tight integration of sensors, processing, and control with rapidly switchable adhesives creates new opportunities for dexterous manipulation of underwater objects in compact systems without prior knowledge of the environment. This functionality was demonstrated in a wearable adhesive glove where the ability to pickup and release a variety of items underwater (including flat, curved, rigid, and soft objects) was confirmed. These capabilities mimic the advanced manipulation, sensing, and control of cephalopods and provide a platform for synthetic underwater adhesive skins that can reliably manipulate diverse underwater objects.

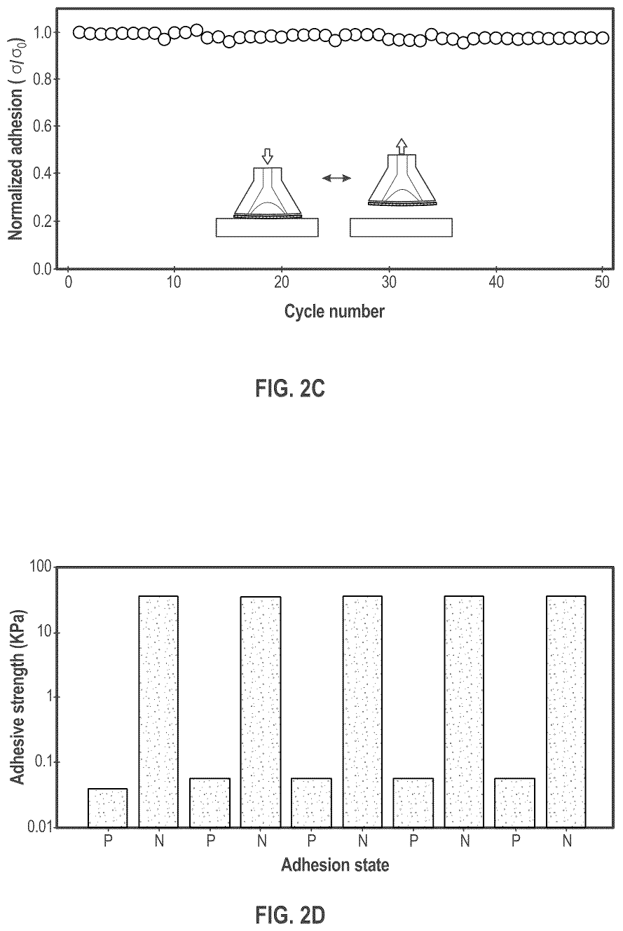

Adhesive elements 103 were made from silicone elastomers, with the stalk 106 being created with Dow Corning Sylgard 184 elastomer and the membrane 109 from a more deformable Smooth-On Dragon Skin elastomer to accommodate large deflections. The stalk 106 was fabricated using 3D printing molds with a prescribed geometry and then casting and curing the silicone elastomer. The stalk angle α is defined as the angle of the stalk near the contact surface as shown in FIG. 2A. The membrane 109 was cast, partially cured, and then bonded to the stalk 106. The adhesive element 103 was then connected to a pressure source that supplies positive, neutral, and negative pressure to control the shape of the active membrane 109.

Adhesion strength of the adhesive elements 103 was characterized for positive, neutral, and negative membrane pressurized states. This was performed on a custom testing setup that fully submerged the adhesive and substrate and pneumatically controlled the membrane state. FIG. 2A schematically illustrates the sequence of testing for an adhesive element 103 with negative pressure (ON state). First, the adhesive element 103 approached an acrylic substrate 102 until a predefined preload was reached. Next, a negative pneumatic pressure was applied to activate the adhesive membrane 109. The adhesive was then held in place for 5 seconds and subsequently pulled from the substrate until separation was achieve. The adhesive element 103 was retracted and the testing repeated as desired.

The results for a positive, neutral, and negative pressure on an adhesive element 103 with a stalk angle of α=¿ 15° are shown in FIG. 2B. The stress versus time plot displays the preload, dwell, and retraction data for three different pressurized states. Here, it can be seen that the negative state results in an adhesive stress of above 60 kPa. This contrasts with the low adhesive stresses for the positive and neutral states. The inset in FIG. 2B shows a zoomed in view of the pull off region of the plotted stress, indicating that the positive state produces a lower adhesive strength than the neutral state due to the inflation and reduced contact with the substrate 102. This mechanism functions in both dry and underwater conditions. Because soft elastomer materials are utilized for the membrane 109 and stalk 106, the adhesion is reversible and durable.

To demonstrate the reversibility of the adhesives, a cyclic experiment was performed where negative pressure was applied, and the adhesive strength was measured over 50 consecutive experiments. A stalk angle of α=¿ 15° was selected for the adhesive element 103 and, as shown in FIG. 2C, it was found that the adhesive was consistent over the tested cycles. The adhesive strength was normalized by the first cycle, and no degradation was observed over 50 cycles illustrating its reusability. By controlling adhesion through the active membrane 103, it is possible to rapidly switch between high and low adhesive states. The pneumatic system was programmed to first perform an experiment with positive pressure and then switch to a negative pressure for the next cycle. This results in the ability to actively switch between a low and high adhesion state repeatedly over 5 cycles for each state. FIG. 2D shows cyclic adhesion test of an α=¿ 15° adhesive element 103 alternating between positive and negative membrane states for high strength and release. Taken together, these results show the ability to generate significant adhesive strength underwater, to be reusable over many cycles, and to achieve reversible switching between high and low adhesive states.

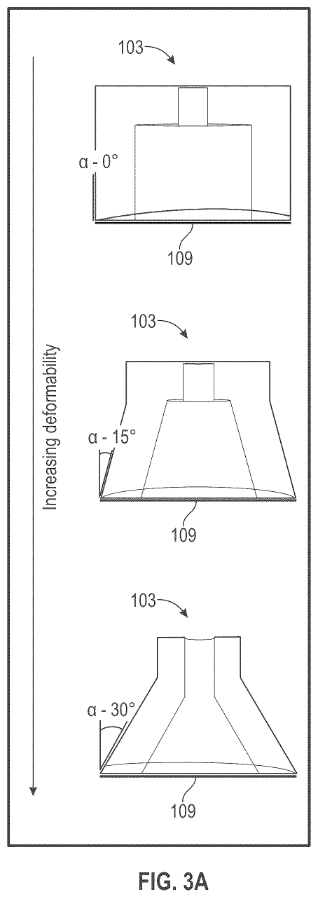

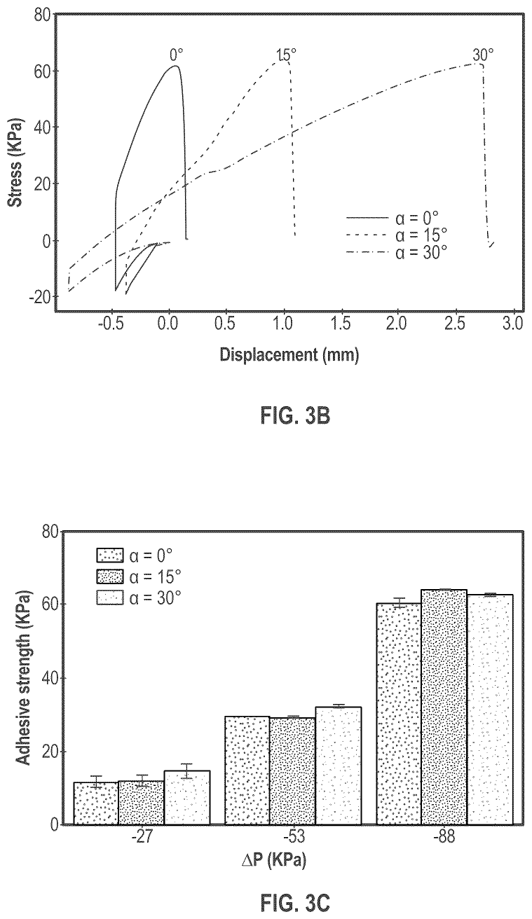

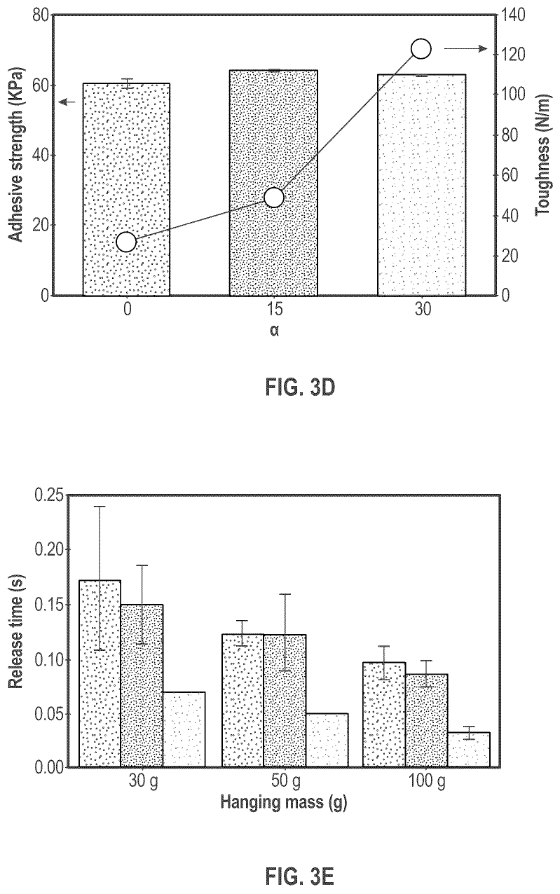

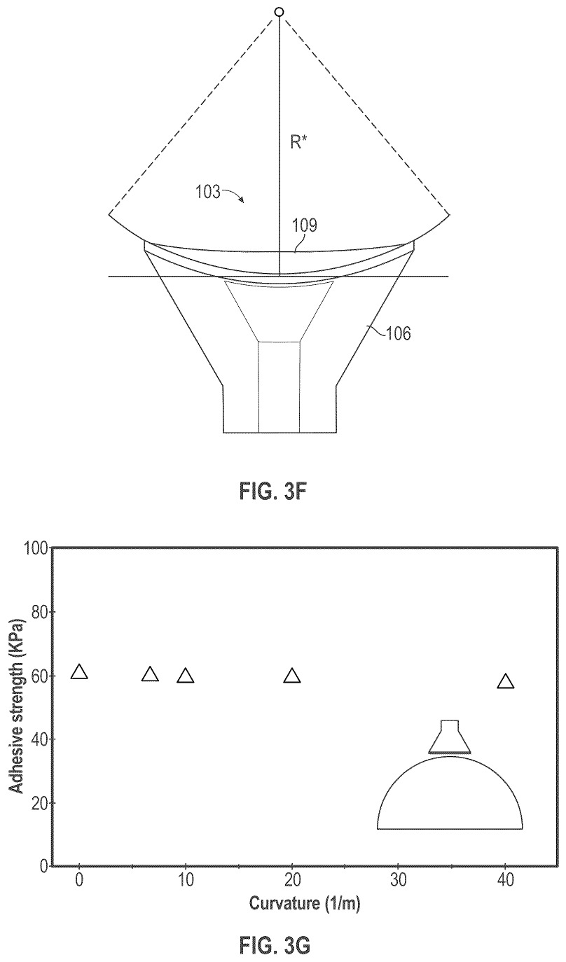

In unstructured environments, it is important that the adhesives are tolerant to angular misalignment. One way to improve contact creation is by increasing adhesive deformability. Here, the compliance of the adhesive elements can be tuned through stalk shape variation by changing the stalk angle (α). FIG. 3A shows adhesive elements where the stalk angle α varies between 0°, 15°, and 30° while maintaining a constant contact area and height. The effect of the stalk angle α on the ON state adhesive stress on a flat surface was first evaluated using an equivalent preload. FIG. 3B shows underwater contact adhesion experiments where changing α adjusts the compliance of the adhesive element 103 both as it is compressed and retracted. The graph represents the displacement versus adhesive force for each of the three stalk angles. Relative to the stiffness of the α=¿ 0 stalk, the stiffness during retraction decreases by a factor of 2.2× and 5.4×for the α=¿ 15° and 30°, respectively.

The deformation of adhesive elements 103 during retraction was further simulated in finite element (FE) analysis. These results show a decreasing stiffness with increasing stalk angle, where the stiffness decreases 5.1× as stalk angle changes from 0° to 30°, showing excellent agreement with the experimental results across this range. Both experiments and simulation show the ability to control contact compliance by changing the stalk angle.

The influence of α and pneumatic or hydraulic pressure (ΔP) on adhesive strength is shown in FIG. 3C for all three stalk angles under various negative pressures. First, for a given α, increasing the magnitude of the negative pressure results in greater adhesive strengths. This enables controllable adhesion strength by tuning the applied negative pressure. Pull-off velocity can also tune adhesive strength, where increasing adhesive strength was found with increasing pull-off velocity. Second, for a given ΔP, the adhesive strength remains the same irrespective of α. Even for the maximum negative pressure, a similar adhesive stress of greater than 60 kPa is found for all three stalk angles.

Testing went as low as −88 kPa in this study as it balanced the time to pump down, considerations for sealing, and negative pressure generation. Although all the samples have the same maximum adhesion strength, the compliant adhesive element 103 with α=¿ 30° is advantageous as it provides for a tougher adhesive and the ability to conform to different surfaces with angular misalignment. The toughness is evaluated by the overall work needed to remove the adhesive during separation. The most compliant sample of α=¿ 30° takes more work for removal even as the adhesive stress is the same as other angles. FIG. 3D is a plot showing the ability to achieve high adhesive strength and tunable adhesion toughness by changing the stalk angle α (data are for ΔP=¿−88 kPa.), where the black line with circular symbols refers to the toughness. This effective change in stiffness allows for the α=¿ 30° adhesive element 103 to exhibit a 4.6× higher work of fracture relative to the α=¿ 0° sample under the same loading conditions. This shows the capability to increase the work of fracture of the adhesive by changing the sample geometry without sacrificing adhesive strength.

The adhesives can also be switched from an ON state to an OFF state while supporting a load. Rapid switching performance for different stalk angles α=0°, 15° and 30° were examined using masses of 30, 50, and 100 grams. The underwater switching tests were preformed by lifting a mass in the negative pressure state and then switching to the positive pressure state. For this experiment, the positive pressure was approximately 5 kPa and the negative pressure was −88 kPa. This transition inflates the membrane to reduce the adhesion and rapidly drops the mass. The time needed to drop a mass after triggering the adhesion change was compiled. FIG. 3E shows the release times for three different masses for all three stalk angles. Error bars represent the standard deviation for n=¿ 3. The release time decreases for increasing mass, and that the α=¿ 30° shows the most rapid release. All stalk angles release the mass in less than 200 ms, with the adhesive element 103 with α=¿ 30°releasing the 100 g mass in less than 40 ms, showing the ability to rapidly switch from a high to low adhesion state underwater.

Taken together, these results show the ability to achieve high adhesion strength and toughness while also being able to rapidly (<0.1 s) and controllably switch adhesion to the OFF state. This combination of strength, toughness, and release is often contradictory in adhesives, yet is achieved here through the combination of stalk geometry and active control of membrane curvature in these soft, octopus-inspired adhesives. This represents an exceptional combination of underwater adhesion switching characteristics which is uniquely enabled by the ability to control deformation through the stalk geometry for toughness, while being able to actively control the membrane geometry for strength and rapid release.

The shape of the stalk can be modified by changing the curvature of the contacting surface with the membrane 109. FIG. 3F illustrates an example of the adhesive element 103 having a curvature with radius R. This configuration can improve the ability to create adhesion on curved surfaces, where a high adhesive strength (approximately 60 kPa) can be maintained as the surface becomes more curved. FIG. 3G is a plot showing the ability to maintain a high adhesive strength with different curvatures.

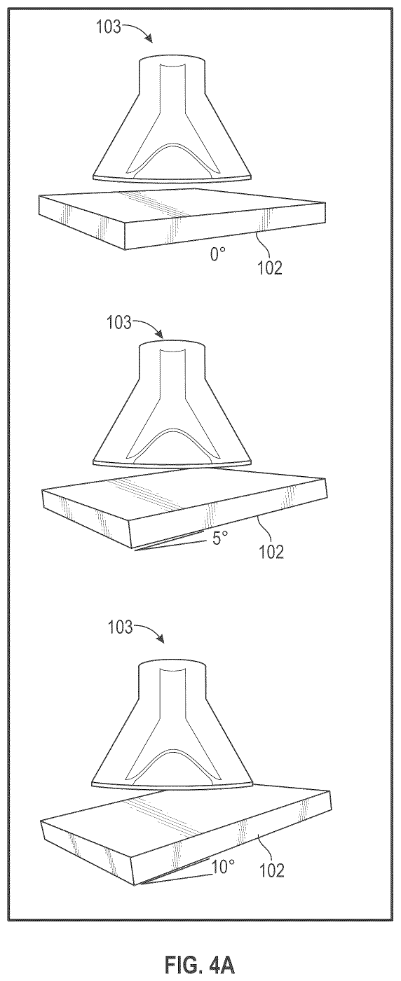

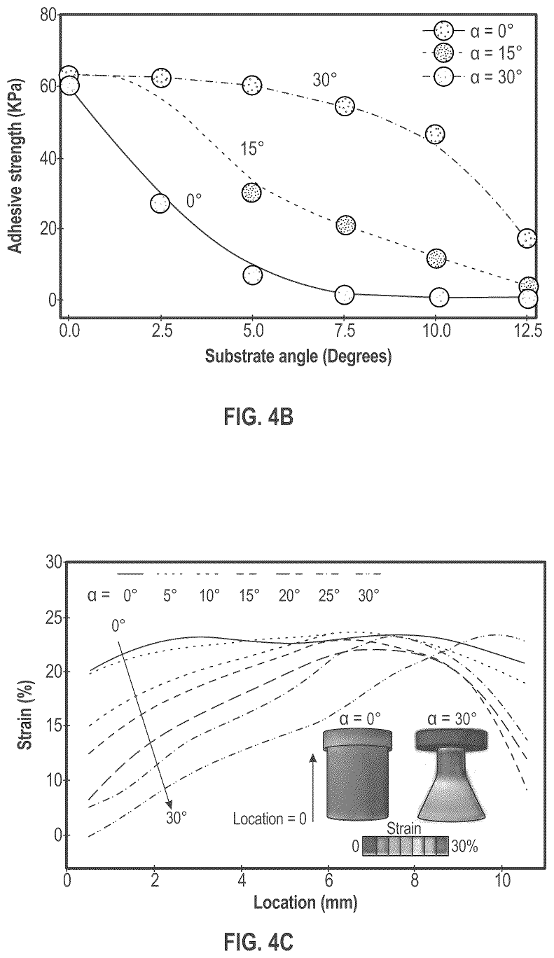

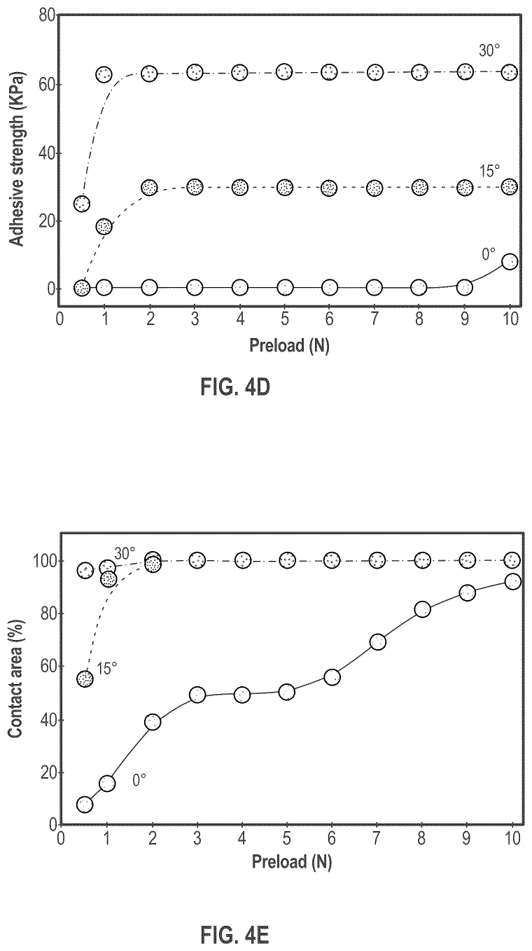

In unstructured environments, adhesives may not always be well aligned with substrates of interest. The misalignment tolerance of the adhesive elements 103 was studied by characterizing the adhesion properties against inclined substrates 203 with different angles relative to the plane of the adhesive element 103. FIG. 4A schematically illustrates the change of substrate angle from 0 to 10°. FIG. 4B presents the adhesive strength as a function of substrate angle ranging between 0-12.5°for same preload of 3 N (17 kPa). The adhesive strength of the α=¿ 30° stalk angle is maintained for inclined angles up to 5° and is the only element capable of adhering with a substrate inclination >10°. The α=¿ 0° adhesive element fails to achieve any adhesion above inclined angles of 5°, as the element is no longer able to create contact, highlighting the importance of compliance for contact generation.

The FE model was further utilized to characterize the deformation along the stalk 106 for different stalk angles (α). FIG. 4C shows the strain profiles along the stalk 106, where the location axis starts from the tip of membrane. The graph of FIG. 4C shows the strain percentage as a function of the location of the adhesive element under adhesion. The insets show the strain distribution on the FEA models for the deformed adhesive elements 103 with α=¿ 0° and α=¿ 30°. An equal displacement of 2.5 mm is used for all angles to compare strain profiles. The smaller angles (e.g., 0°) show relatively uniform strain distribution with high strain near the contact area (near the 0 mm position). Conversely, for larger stalk angle α (e.g., 30° or more), the strain is noticeably smaller near the contact location which gradually increases towards the base. This behavior indicates that adhesive elements 103 with larger α experience smaller strain near the contact zone while the thin region of the stalk 106 elongates significantly. The stress distribution also shows lower stress near the contact zone and greater stress in the thin stalk region for α=¿ 30°. These results indicate that the negligible strain of the α=¿ 30° adhesive element 103 near the contact area ensures minimal disturbance of the flexible membrane 109 for robust adhesion performance, even when the adhesive element 103 is significantly misaligned.

Next, a constant substrate angle of 5° was used to examine the adhesive strength dependence on preload. Here, the amount of preload was increased from 0.5 to 10 N and the maximum adhesive strength was reported for each stalk angle. The graph of FIG. 4D illustrates the adhesion strength dependence on preload evaluated on the substrate angle of 5°. FIG. 4D shows that the α=¿ 30° adhesion element 103 achieved adhesion even for a low preload of 0.5 N (2.8 kPa) and then reached a maximum adhesion strength above 60 kPa for 1 N (5.7 kPa) preload. For the α=¿ 15° element, adhesive strength begins to develop for the 1 N preload and then plateaued at a moderate adhesive strength of 30 kPa at a 2 N prelaod. The 0° adhesive element 103 needed at least 10 N preload to develop any adhesion strength, and even at that point only shows a low adhesion strength of 10 kPa, significantly smaller than the more compliant elements.

The preload on adhesive elements 103 is an important factor for creating contact with the substrate. This was further examined using FE analysis to determine contact area as a function of preload. Here, the contact area was calculated as a ratio of contact nodes to total nodes of the membrane 109 during compression of adhesive elements 103 onto a 5° inclined surface. The summarized contact area analysis for α=¿ 0°, 15°, and 30° are presented in FIG. 4E, which illustrates the percentage of contact area on the 5°s ubstrate as a function of preload. By comparing the adhesive strength and contact area in FIG. 4E, it can be seen that successful adhesion develops when 90% of the adhesive element 103 is in contact with the substrate. This condition can be interpreted as the minimum contact area needed to ensure the membrane component is in contact with the substrate. The stiffer α=¿ 0° and 15° adhesive elements 103 need a high preload to satisfy the contact area condition to initiate adhesion with inclined substrates. In contrast, the highly flexible adhesive elements 103 having α=¿ 30° can meet the contact area requirement with low preload. This reduced preload is considerably advantageous as it allows for robust contact and strong underwater adhesion without pressing hard into substrates. These results are clear indicators of the conformal adhesion mechanism of the octopus-inspired adhesive elements 103 and point to the importance of stalk design to strongly adhere underwater in unstructured environments.

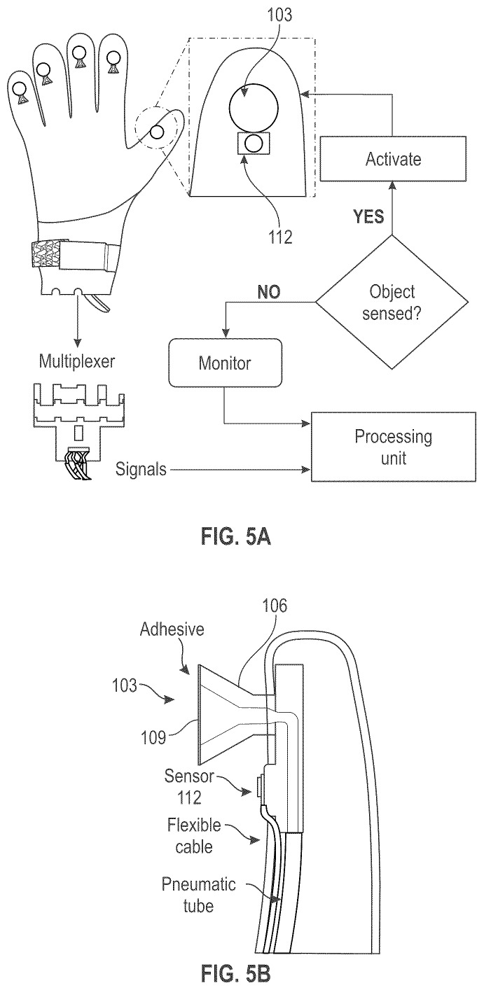

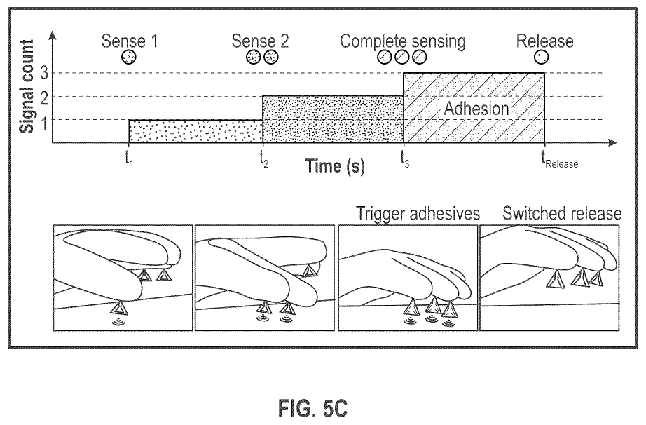

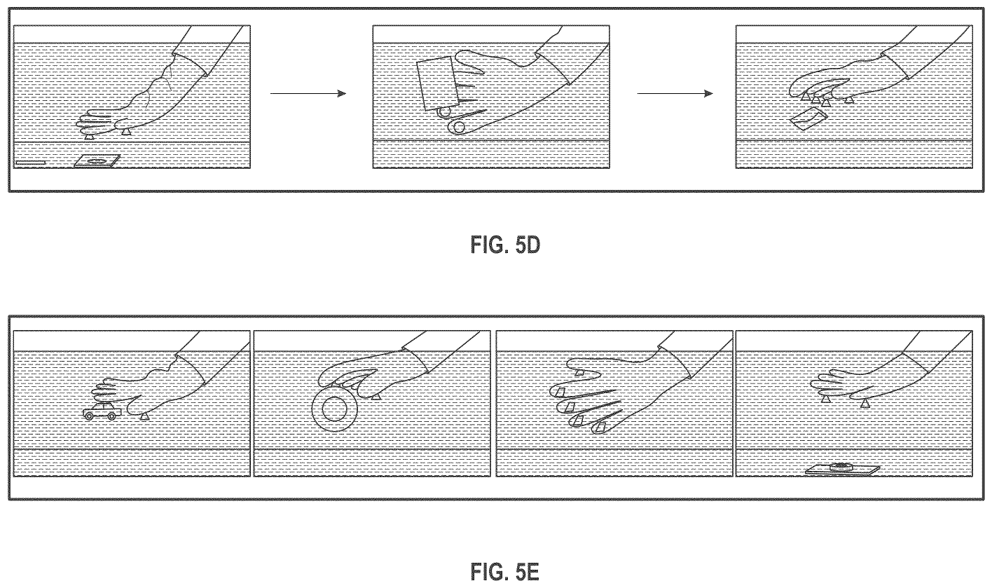

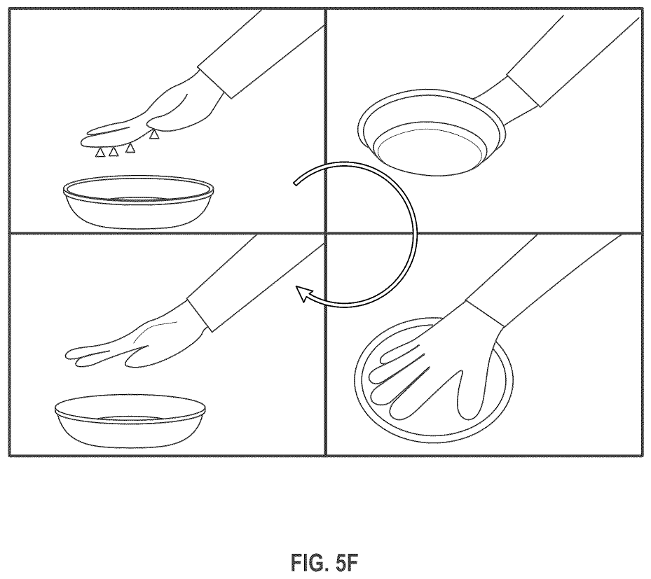

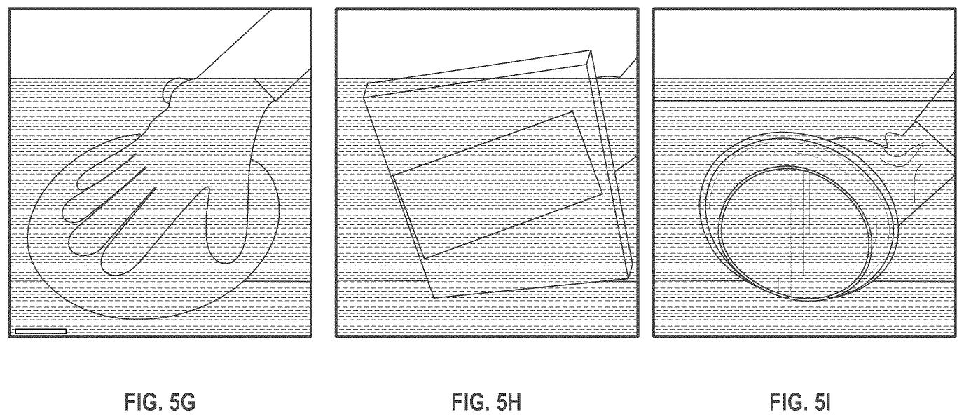

The adhesive elements 103 were tightly integrated with a sensorized skin to create a wearable glove for autonomous adhesion control and dexterous manipulation of underwater objects. FIG. 5A illustrates an example of a wearable adhesive glove with integrated adhesive elements, sensors, processing, and control showing the logic layout to activate adhesion. Each finger of the glove can comprise an active adhesive element 103 and micro-LIDAR optical sensor 112 for proximity detection. The array of optical proximity sensors 112 can be connected to a microcontroller 115 or other processing circuitry using, e.g., a multiplexer where the proximity data can be collected to determine if an object has been detected. If an object is within a defined sensing range of the proximity sensor 112, a digital signal can be sent to activate a solenoid-controlled pneumatic device (e.g., trigger or valve) for rapid activation of the adhesive elements 103. A cross section of a finger from the sensorized glove including the embedded sensor 112 and adhesive element 103 is shown in FIG. 5B. An optical proximity sensor 112 was fixed to the elastomeric platform that contained the adhesive element 103. A flexible sensor cable and pneumatic tube can be routed inside the glove.

Adhesion with complex geometry was aided by the ability of α=¿ 30° adhesive elements 103 to conform to a surface with a small preload. Sensorized gripping with the glove is illustrated in FIG. 5C by a sequence of schematics and corresponding time plot. The sequence of the sensorized adhesive elements 103 shows the adhesion triggering after complete sensing by three sensors 112 followed by switched release. Different adhesive activation modes can be achieved by controlling the proximity range for object detection and actuation timing for a selected group of sensors. For instance, the adhesive elements can be programmed to activate after three sensors 112 detect an object as shown in FIG. 5C. Notice that the adhesive elements 103 are inactive in the first three sensing instances (t<t₃). When three sensors 112 recognize a substrate at t₃ a digital signal is sent to actuate the pneumatic trigger, which initiates rapid adhesion. The release can also be performed by switching off the adhesive element 103 at t_{Release}.

Both the sensorized skin and adhesive elements function while submerged, enabling the wearable glove to manipulate diverse objects underwater. To manipulate delicate and lightweight objects, a single sensor mode can be utilized to activate the adhesive elements 103. FIG. 5D includes images showing that the index finger can recognize a small card and trigger adhesion. A single adhesive activation mode. can be used to sense, grip, and release the lightweight paper card in the underwater environment. The negatively pressurized adhesive element 103 attaches to the card and then the user rotates their hand to show the logo in the middle image of FIG. 5D. The card can then be released on demand as shown in the right image of FIG. 5D. The images of FIG. 5E show underwater manipulation of other small and lightweight items with different shapes and materials. The underwater manipulation with a single adhesive element 103 and sensor 112 to adhere and pickup, e.g., a metal car, a metal toy car, cylindrical rubber tape, the doubly curved convex portion of a plastic spoon, and an ultrasoft hydrogel ball. FIG. 5E demonstrates adhesion to flat, cylindrical, convex, and spherical surfaces across hard and soft materials.

It is also possible to grip larger objects with a combination of adhesive elements 103 by reconfiguring the sensor network to utilize all sensors 112 for object detection. Here, the microcontroller 115 can be programmed to actuate the pneumatic trigger after a combination of three of the sensors 112 detect the proximity of an object within a defined sensing distance. This mode ensures contact of all the adhesive elements 103 with the substrate or object before activating adhesion. FIG. 5F shows the use of a fully-functional adhesive glove for gripping the concave surface of a metal bowl. The images of FIG. 5F demonstrate the use of multiple adhesive elements 103 and sensors 112 on the adhesive glove to grip, lift, and release the large metal bowl in water. The adhesives approach the object as shown in image (i) of FIG. 5F and then autonomously activate adhesion to enable easy lifting and handling of the bowl as shown in images (ii) and (iii) of FIG. 5F before activating release as shown in image (iv) of FIG. 5F. This functionality is repeated in FIGS. 5G, 5H and 5I to manipulate a plastic plate, an acrylic box, and a metal plate, demonstrating dexterous underwater manipulation of different materials with a range of surface reflectivity. All scale bars are 5 cm in FIGS. 5D-5I.

An underwater manipulation system has been introduced by tightly integrating sensing, processing, and control with rapidly switchable adhesives. This is enabled by adhesive elements 103 that switch adhesion 450× from the ON to OFF state quickly (<0.1 s) with the ability to be reused over multiple cycles. By tuning adhesive element compliance through the stalk architecture, reliable attachment can be achieved in unstructured environments at low preloads. This functionality was demonstrated in a wearable adhesive glove to autonomously activate adhesion to pick and release a variety of items underwater including flat, curved, rigid, and soft objects. These capabilities mimic the advanced manipulation, sensing, and control of cephalopods and provide a platform for synthetic underwater adhesive skins that can manipulate diverse underwater objects.

One of the enabling features of this octopus-inspired adhesive system is real-time object detection coupled with rapidly switchable adhesives. This allowed for manipulation of diverse objects at time scales relevant to human movement. This was achieved due to the low preload needed to activate adhesion on different substrates by optimizing the architecture of the adhesive stalk 106. This low preload adhesive activation coupled with the object detection enables this octopus-inspired adhesive system to provide real-time object detection coupled with rapidly switchable adhesives. This allows manipulation of diverse objects at time scales relevant to human movement. This can be achieved due to the low preload needed to activate adhesion on different substrates by optimizing the architecture of the adhesive stalk 106. This low preload adhesive activation coupled with the object detection through sensing and rapidly switchable adhesives is an important combination to achieve underwater manipulation with autonomous gripping and release.

Tuning stalk compliance also enables independent control of adhesive strength and toughness. This increase in toughness can be achieved while maintaining the ability to rapidly release objects. This combination is unusual as higher adhesion toughness is typically achieved with enhanced inelastic dissipation, which can make release difficult and typically increases switching time. Therefore, control over adhesive strength, toughness, and release is important for efficient manipulation. The strength allows for relatively heavier objects to be manipulated, the toughness allows for tolerance to perturbations during manipulation where the adhesive element 103 can deform while still grasping the object, and the ability to trigger a low adhesive state allows for objects to be released despite the higher strength and toughness. This combination of controlling strength and toughness with rapid release is an exceptional combination of adhesive properties that is achieved in this system and is extremely advantageous for underwater manipulation. Evaluation of negative/positive pneumatic or hydraulic pressure differential, membrane geometry, stalk geometry, water depth, and object characteristics can establish the full range of ON/OFF ratio characteristics for the switchable adhesive elements 103. Furthermore, microfabrication strategies can enable device downscaling and integration with microfluidic channels which can allow for multiplexing the pneumatic system.

Although this study is focused on optical sensors, different sensing modalities can also be employed. Chemical or mechanical sensors can be synergistic, and can offer a diverse set of vision, chemical, and mechanical sensing during manipulation. Haptic feedback can also be integrated into this system to alert a user when adhesive elements 103 are activated (e.g., by including an internal feedback surface in the fingers of the glove) and this can allow for tuning of the control scheme for customizable underwater manipulation. Further, while the use of pneumatic activation for the adhesive elements 103 was the focus of this disclosure, other types of switchable adhesives may be utilized with the understanding that keeping the switching time (i.e., the time to activate or release the adhesive element) on the order of seconds or less allows for active manipulation without needing to prime the system or wait extended amounts of time in contact.

The octopus-inspired adhesive skin can also be deployed as an unthetered system. For example, untethered soft material actuation can utilize pneumatic systems (e.g., pumps, valves, electronics, batteries) on the order of 500 g that can be carried by or within a soft robot itself. Miniature pumps can run on 10 W and it has been shown that low power soft pumps can consume as little as 100 mW. The pneumatic membrane in adhesive elements 103 can provide a closed system which could allow for the pneumatic system to be powered off after activation (i.e., with no power consumed during gripping/manipulation) which can provide power savings. The disclosed adhesive system 100 can be used for robotic manipulation, manufacturing, and health care for programmed or autonomous manipulation of surfaces, materials, and tissues in dry or wet environments.

Adhesive Element Manufacturing and Preparation: Molds were created from a DLP 3D printer (B9 Creations) with variations in the stalk angles α of: 0, 15, 30° with an adhesive element diameter of 15 mm. The adhesive elements 103 were fabricated with Polydimethlysiloxane (PDMS) (Sylgard 184 with a 10:1 ratio), by pouring elastomer into 3D-printed molds and curing at 80° C. for 8 hours. The PDMS was removed and treated with oxygen plasma for 1 minute prior to placement onto a 500 μm silicone membrane 109 (Dragon Skin 00-30, Smooth-On), which was partially cured at 80° C. for 2 minutes. The adhesive element 103 and partially cured membrane 109 were cured at 80° C. for 4 hours. A 20-gauge needle attached with pneumatic tubing, was inserted into the base of each sample where a fluid channel was located. A silicone adhesive (Sil-Poxy, Smooth-On) was used to seal the inserted needle to the sample.

Adhesive Testing: Adhesive elements 103 were tested through normal adhesion experiments on an Instron 5944 load frame. Adhesive elements 103 were lowered onto an acrylic substrate and compressed to a force of 3 N or about 17 kPa and held for five seconds while the desired pneumatic state was activated. The sample was then retracted at a rate of 1 mm/s until separation from the substrate. Each sample was tested with positive pressure, neutral pressure, and 27, 53 and 88 kPa of negative pressure. An additional test was conducted outside of water with the same set up to determine the effects of a dry substrate. Angled substrate tests were performed with a tilted, acrylic substrate at angles of 2.5, 5, 7.5, 10, and 12.5°. Each sample was lowered onto the substrate with a preload of 3 N and subjected to the maximum negative pressure of 88 kPa.

Finite Element Analysis: The computational models of adhesive elements 103 were developed using the finite element (FE) analysis program ABAQUS/Standard (SIMULIA, Providence, RI) as 3D deformable bodies. 8-node linear brick elements C3D8R, which uses reduced integration with enhanced hourglass control, were utilized. An adhesive element with a stalk angle α=¿ 30° was considered for stress and strain profiles. The stalk 106 (PDMS) and membrane 109 (Dragon Skin) of the adhesive element 103 were formulated using hyperelastic Yeoh model53 materials. The material coefficients C₁₀=¿ 0.19 MPa, C₂₀=¿ 0.21 MPa, C₃₀=¿ 0.01 were used for PDMS and C₁₀=¿ 0.37 MPa, C₂₀=¿ 0.005 MPa, C₃₀=¿ 0 were employed for Dragon Skin. The semi-rigid adhesion contact was replicated using spring boundary condition (1 N/mm for each spring) at the bottom surface of the membrane 109. This value was tuned to fit with the experimental result.

The contact area analysis in FE was performed using the same material properties for the adhesive element 103. However, the membrane boundary conditions were changed to a friction contact between the adhesive surface and the inclined substrate. A nonlinear friction coefficient was used as a function of preload, which was used for the analysis of all stalk angles.

Wearable adhesive glove: The wearable adhesive glove was developed from a neoprene wetsuit glove (e.g., 3 mm NeopSkin Water Gloves) which hosts the adhesive elements 103 and sensors 112 in each finger. The adhesive elements 103 were cut into rectangular pieces to fit the glove fingers and flexible pneumatic tubings with 0.8 mm ID were inserted at the base of the adhesive elements 103. The sensing in the glove was achieved using a micro-LIDAR optical sensor (e.g., STMicroelectronics VL6180X) that is wired together using flat flexible cables (Molex). A sensor 112 was attached to each adhesive element 103 (see FIG. 5A) using silicone adhesive (Smooth-On Sil-Poxy) with an unobstructed field of view. The sensors 112 and flat flexible cable joints were spray-coated with a thin, waterproof layer of conformal coating (e.g., Humiseal 1A33 Aerosol). The pneumatic tubes from the adhesive elements 103 were combined using a heat shrink wrap and fit to a solenoid valve (e.g., Spartan Scientific 2-Way/2-Position Valve) through a plastic tube (e.g., PureSec CCK RO Tubing). The inlet of the solenoid valve was attached to a vacuum pump. Multiple optical sensors 112, which have a fixed I2C address, were connected to a single microcontroller 115 (e.g., Microchip ATmega2560) using a bidirectional multiplexer (Texas Instruments TCA9548). The microcontroller 115 is used to control the solenoid operated pneumatic system based on the optical sensor network feedback.

In addition to a glove, systems of adhesive elements 103 and sensing elements 112 can be integrated on a surface of other clothing or a device. Adhesive systems can also be attached to a vehicle (e.g., a ship, sub, etc.) and may be attached to a dock or other surface. In addition, adhesive systems can be utilized on a robotic system to enhance gripping and manipulation or placed on surfaces or features in a manufacturing environment. In some embodiments, an adhesive system may be placed directly on skin.

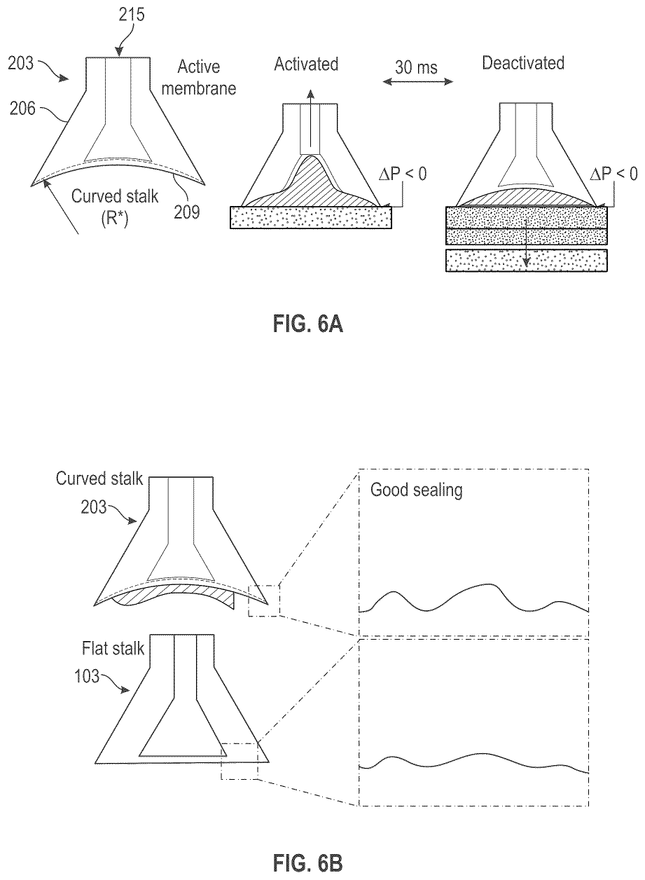

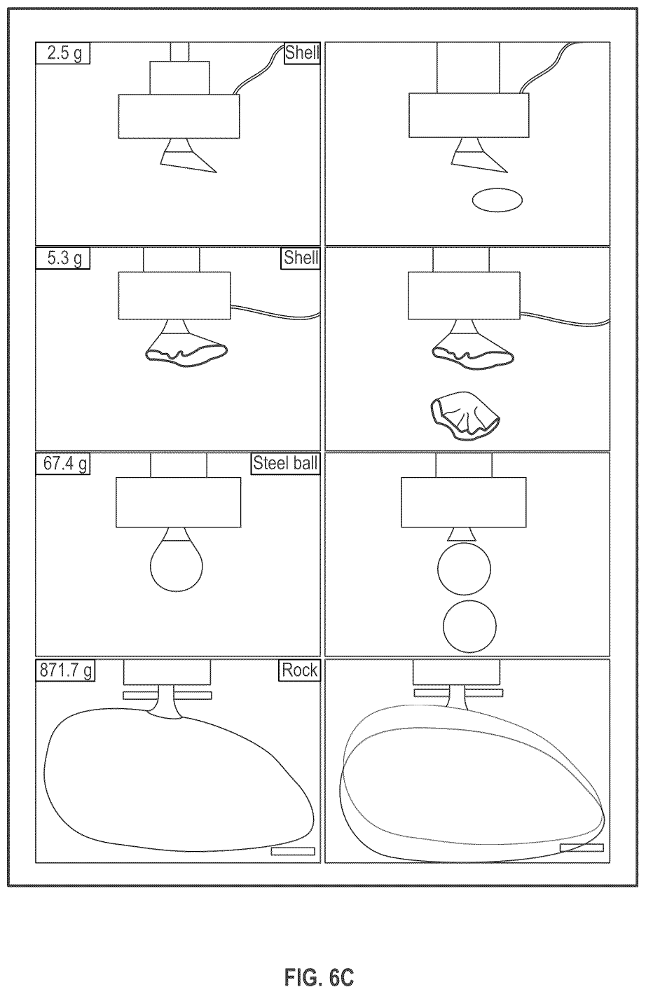

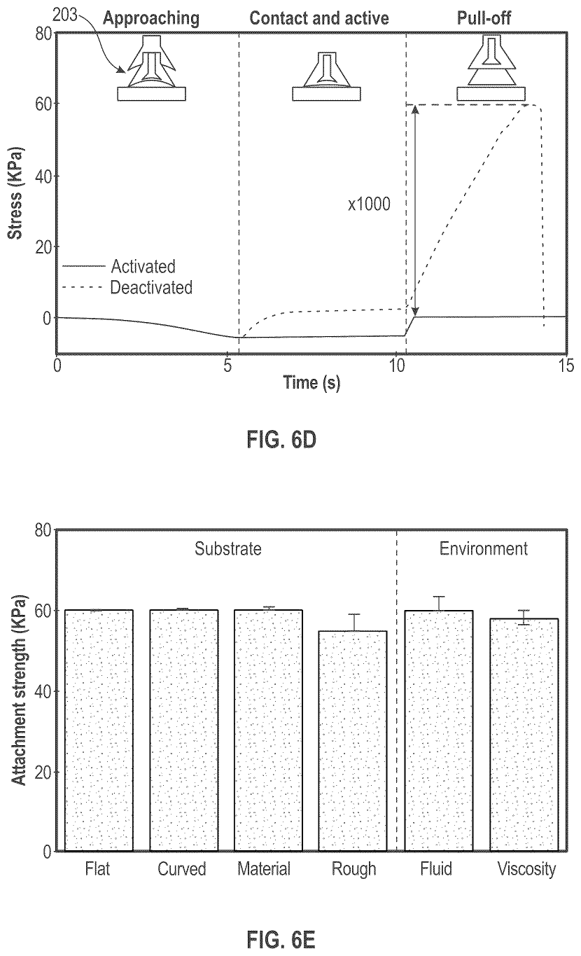

FIG. 6A illustrates an example cross-section of a curved stalk and membrane, and the effect of curvature on the ability to seal in accordance with various embodiments of the present disclosure. FIG. 6A shows a schematic of a switchable adhesive cross-section and actuation of the membrane in the activated and deactivated state. FIG. 6B shows the effect of curvature on the ability to seal interfacial pressure on an irregular surface. FIG. 6C shows attach-and-release examples and an underwater manipulation demonstration on irregular surfaces (scale bar=15 mm). FIG. 6D shows stress versus time for an activated and deactivated switchable adhesive element during a pull-off test underwater. FIG. 6E shows underwater attachment strength on various substrates and environmental conditions.

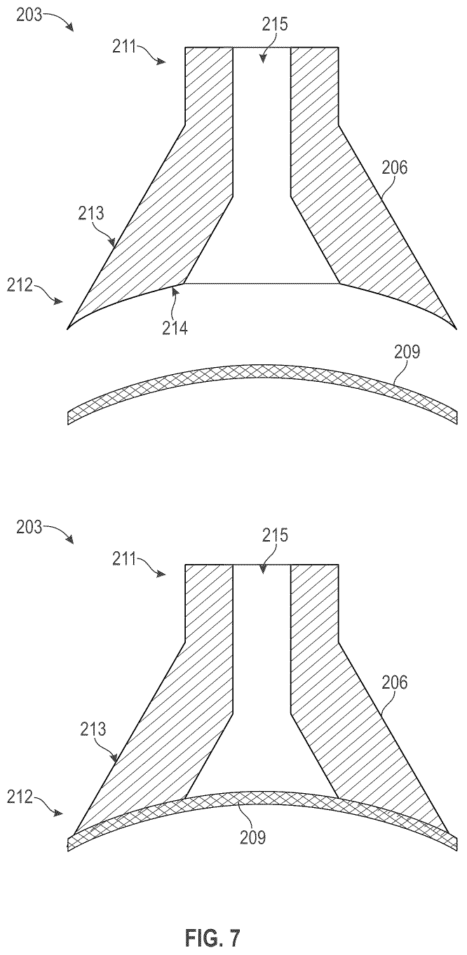

FIG. 7 illustrates a cross-sectional view of another example switchable adhesive element 203 in accordance with various embodiments of the present disclosure. The switchable adhesive element 203 illustrated in FIG. 7 is described in further detail below.

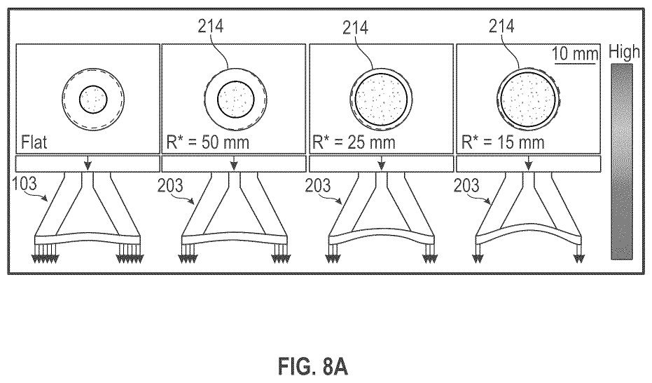

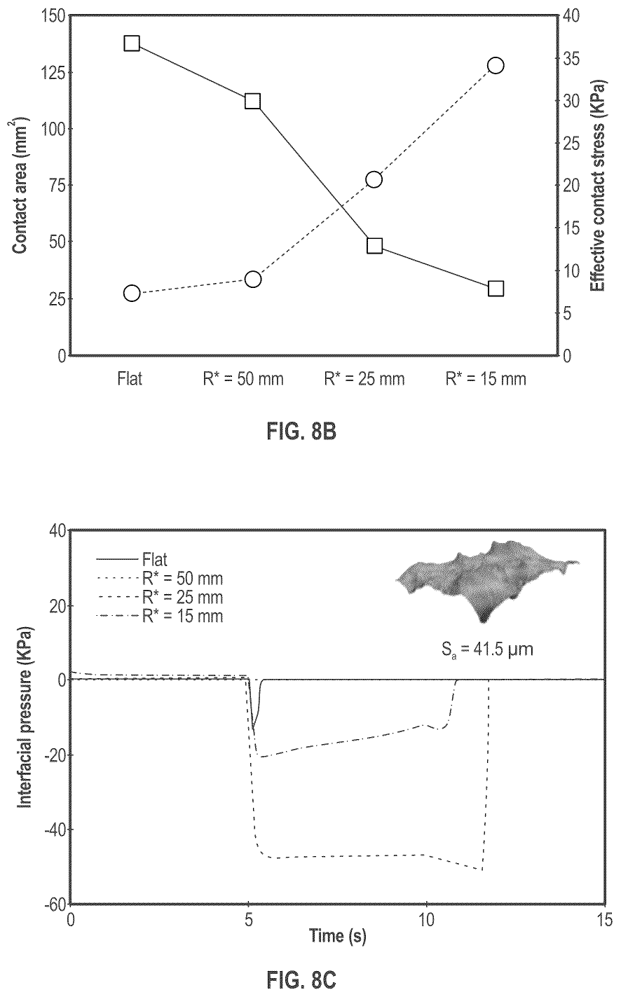

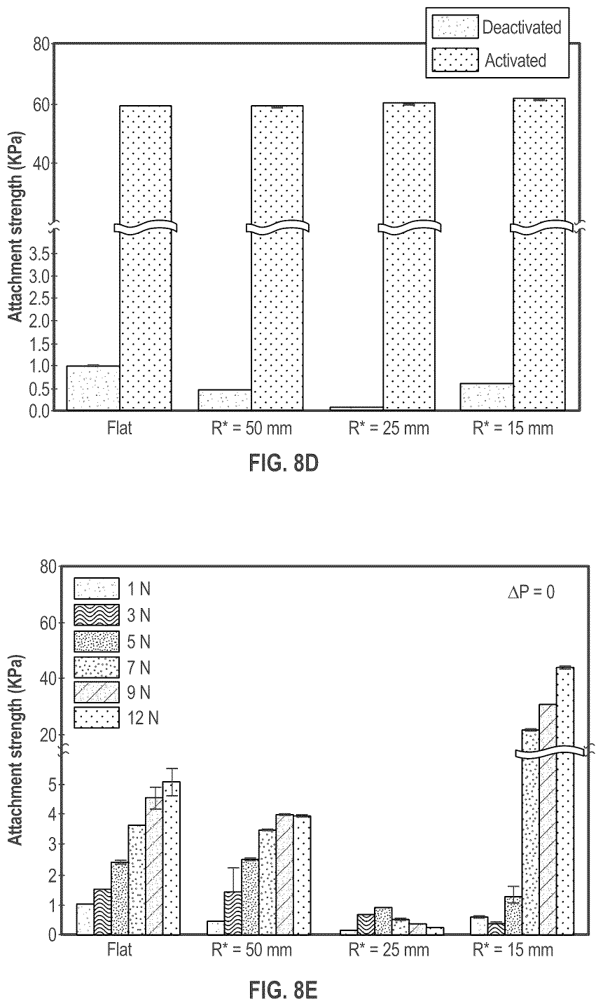

FIG. 8A illustrates example contact area photographs for different stalk curvatures and corresponding schematics showing the effective stress depending on stalk curvature in accordance with various embodiments of the present disclosure. FIG. 8A shows contact area photographs with a 1 N preload for different stalk curvatures and corresponding schematics showing the effective stress depending on stalk curvature. FIG. 8B shows measured underwater contact area with a 1 N preload and calculated effective contact stress. FIG. 8C shows interfacial pressure during an attachment test on a rough, dry surface (Sa=41.5 μm, as shown in the inset). FIG. 8D shows underwater attachment strength in the deactivated (blue) and activated (red) states for different stalk curvature with a 1 N preload. FIG. 8E shows preload dependence of underwater attachment strength in the deactivated state for different stalk curvatures.

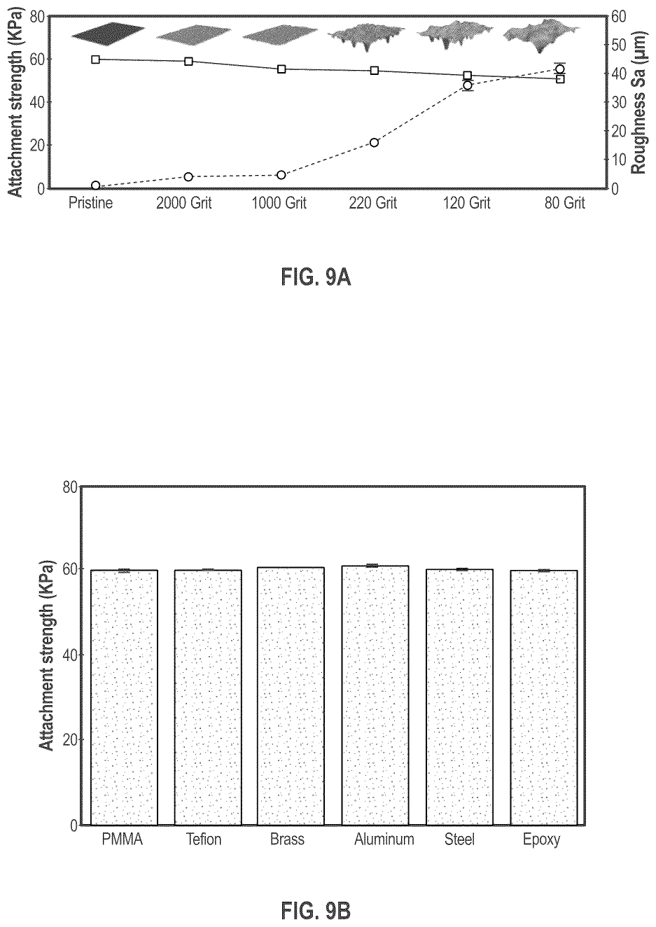

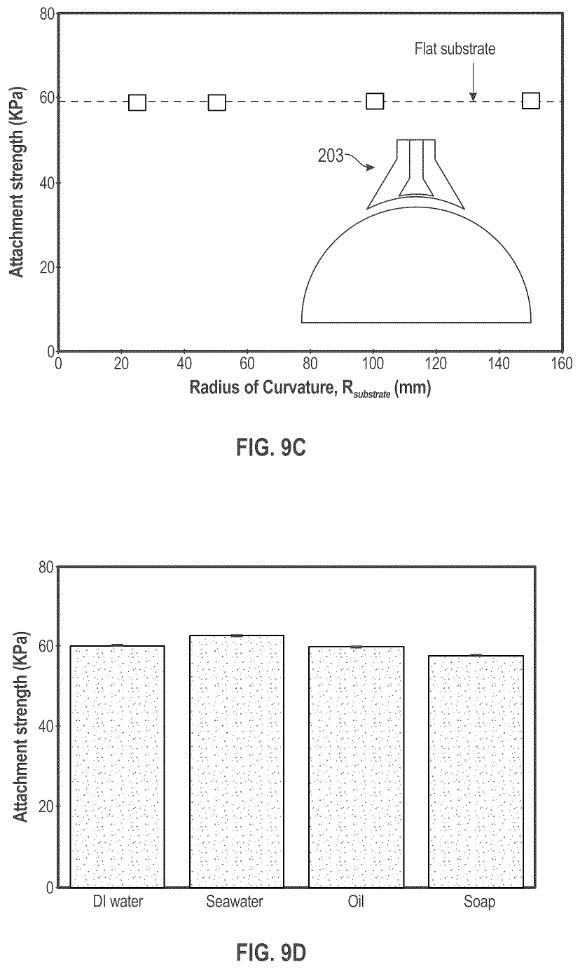

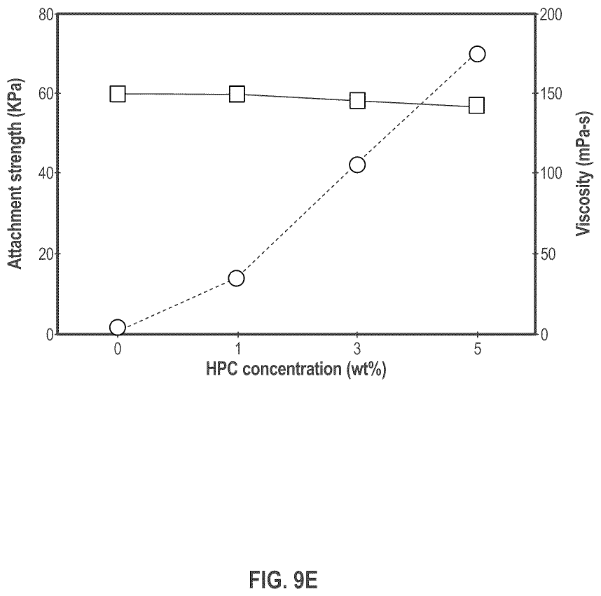

FIGS. 9A to 9E illustrate example underwater attachment strength in accordance with various embodiments of the present disclosure. FIG. 9A shows underwater attachment strength on rough surfaces (Sa: Arithmetical mean height). FIG. 9B shows underwater attachment strength on diverse substrates. FIG. 9C shows underwater attachment strength versus surface curvature. FIG. 9D shows underwater attachment strength in various fluid mediums. FIG. 9E shows underwater attachment strength in viscous fluids.

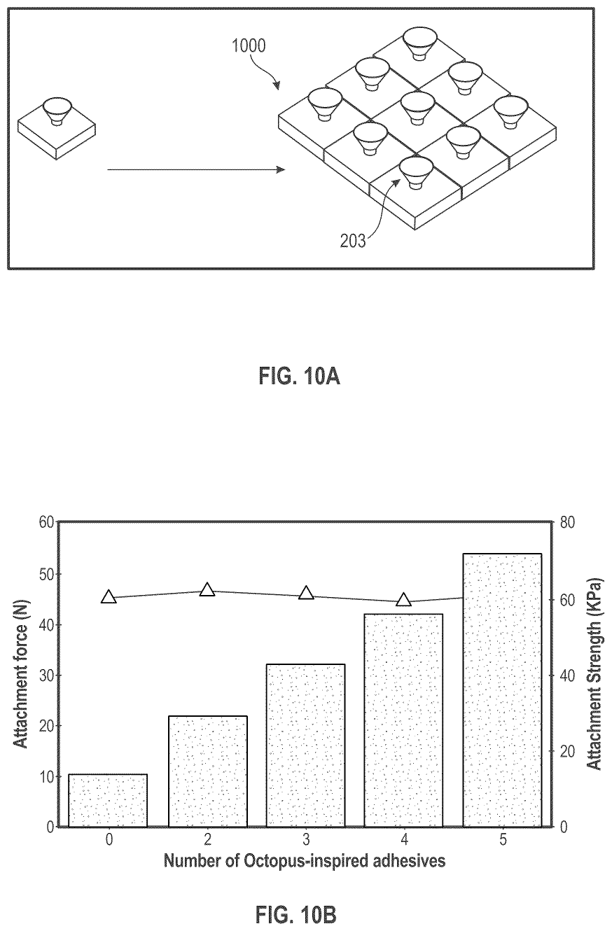

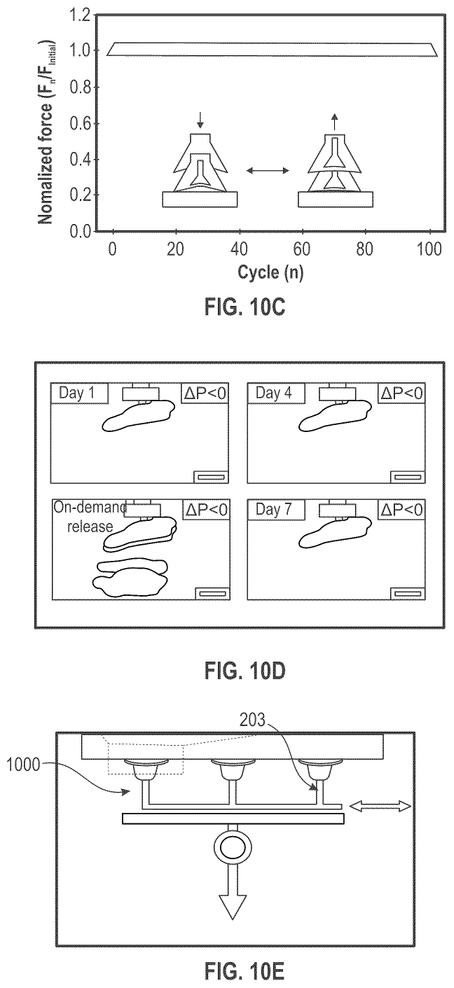

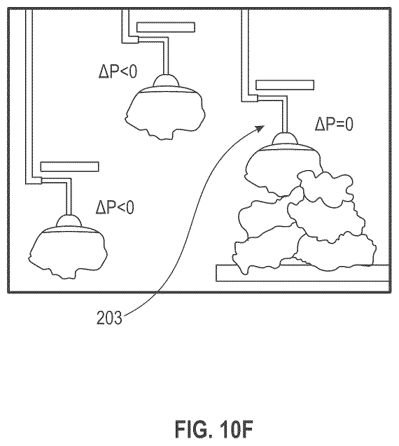

FIGS. 10A to 10F illustrates example scalable attachment strength in accordance with various embodiments of the present disclosure. FIG. 10A shows a perspective view of another example switchable adhesive system 1000 (or “system 1000”) including an array of switchable adhesive elements 203 for scalable attachment in accordance with various embodiments of the present disclosure. FIG. 10B shows underwater attachment force and underwater attachment strength of the system 1000. FIG. 10C shows repeatability of the switchable adhesive element 203 on the system 1000 over 100 cycles underwater. FIG. 10D shows reliability of the switchable adhesive element 203 on the system 1000 for long-term underwater attachment (Scale bar=40 mm). FIG. 10E shows the system 1000 can hold a heavy weight on a rough, underwater surface (Scale bar=100 mm). FIG. 10F shows that the switchable adhesive element 203 in the system 1000 can attach to and controllable release underwater rocks to create a controlled assembly where the rocks have flat, curved, and rough surface features (Scale bar=100 mm). Switching is achieved by deflecting a pressure actuated membrane 209 with pneumatic or hydraulic pressure to achieve attachment switching ratios up to 1000× from the activated to deactivated state. The attachment strength is consistently high (˜60 kPa) across various conditions, including substrate material, substrate curvature and roughness, testing fluid type, and testing fluid viscosity. This approach provides a mechanism for strong yet rapid release to diverse underwater objects and surfaces even in challenging and difficult environments.

As noted above, FIGS. 6A-10F illustrate an example switchable adhesive element 203. Referring to FIG. 7, the switchable adhesive element 203 in this example includes a compliant stalk 206 (or “stalk 206”) and a soft, pneumatically or hydraulically actuated membrane 209 (or “pressure actuated membrane 209”), among possibly other components. The stalk 206 extends from a support end 211 to a contact end 212. The stalk 206 includes a tapered outer surface 213 and a non-linear or curved contact surface 214. The stalk 206 also includes a fluid passage or channel 215 (or “fluid channel 215”) that extends through the stalk 206 from the support end 211 to the contact end 212. The curved contact surface 214 of the stalk 206 is formed to have a curvature (1/R*>0, where R* is the radius of curvature) for enhanced control of contact formation. The tapered outer surface 213 of the stalk 206 also has an external stalk angle, as described herein, for enhanced compliance.

An example diameter of the curved contact surface 214 of the switchable adhesive element 203 is 15 mm, although the switchable adhesive elements described herein can be formed to any suitable size. The pressure actuated membrane 209 can be actuated to attach to and release from objects by applying a pressure differential in the fluid channel 215 through a pneumatic system, where ΔP=Pᵢₙₚᵤₜ−P_{ambient}. Application of negative pressure (ΔP<0) activates adhesion to grasp an object while neutral pressure (ΔP=0) releases an object. The pressure actuated membrane 209 is highly deformable, which effectively communicates the pressure differential in the fluid channel 215 to the interface to generate interfacial pressure for attachment.

The switchable adhesive element 203 can be formed from a variety of suitable materials and in a variety of manufacturing approaches. As one example, the stalk 206 can be cast and cured 10:1 PDMS (e.g., E=1.6 MPa) in a 3D printed mold (e.g., B9R-2-Black photopolymer resin). The pressure actuated membrane 209 can be fabricated by casting 25:1 PDMS (e.g., E=0.4 MPa) on a glass plate using a thin film applicator (e.g., ZUA 2000) and cured at 80° C. for 1 hour in a convection oven. PDMS films and stalks can be treated with oxygen plasma (e.g., 300 mTorr, 5 min) and were then attached with a thin layer of 10:1 PDMS at the interface.

A fluidic/pneumatic system such as the system 100 or the system 1000 illustrated in FIGS. 1A, 10A & 10E can be used to actuate the switchable adhesive element 203, and such a system can be directed by a digital-based control between activated and deactivated states, as well as intermediate adhesion values (depending on the magnitude of pressure applied to the membrane) for precise control of attachment strength. In contrast to film terminated attachment structures, such mushroom shaped pillars, or flat top contacts, on the stalk 206 in the systems described herein can achieve preload over the entire contact structure of the stalk 206 while maintaining compliance at the edge for reliable contact formation.

A primary contribution to attachment by the switchable adhesive element 203 is the utilization of suction through the generation of interfacial pressure between the pressure actuated membrane 209 and a substrate. This pressure differential at the interface is a result of the increase in volume when the pressure actuated membrane 209 is actuated, which reduces the interfacial pressure and creates a hydrostatic stress which can aid in attachment. One challenge is the ability to both generate a stable interfacial pressure for attachment and then rapidly and controllably reduce interfacial pressure for release. The pressure actuated membrane 209 enables the pressure differential to be precisely controlled, which overcomes challenges with controlled release in passive systems. Still, irregular surfaces can disrupt the ability to generate interfacial pressure. This can include surface roughness and curvature which can make it difficult to maintain robust sealing for underwater attachment.

The impact of the curvature of the curved contact surface 214 was quantified for several key parameters for underwater attachment, including effective contact area, sealing performance assessed through interfacial pressure measurements, adhesion switchability, and preload dependent attachment behavior. The attachment was assessed with an example stalk 106 having a flat contacting surface and three example stalks 206 with curved contact surfaces 214 increasing curvature of R*=50 mm, 25 mm, and 15 mm. First, contact area was observed during underwater attachment with a constant preload. This was performed through a custom adhesion setup with a substrate plate that has a frustrated total internal reflection (FTIR) attachment to enhance contrast (FIG. 8A). Image analysis reveals that the effective contact area decreases with increasing curvature of the stalk at a given 1 N preload. The effective contact stress (i.e. force/effective contact area) therefore increases with increasing curvature of the curved contact surface 214 as seen in FIG. 8B, which generates locally high contact stresses which can enhance sealing of interfacial pressure.

The effect of enhanced contact stress on sealing performance was also evaluated by measuring the interfacial pressure during a pull-off test on a rough surface (Sa =41.5μm). Here a pressure sensor is integrated into a substrate to measure the pressure in a dry environment and the pressure actuated membrane 209 was actuated with ΔP<=−85 kPa. Based on the experimental data, flat and R*=50 mm exhibit poor sealing as indicated by zero interfacial pressure or unstable or leaky sealing respectively (FIG. 8C). However, R*=25 mm and 15 mm show high interfacial pressure due to the enhanced conformability on the rough surface. The two samples show different interfacial pressure and sealing characteristics. R*=25 mm has a greater interfacial pressure without noticeable decay of pressure, while R*=15 mm has smaller maximum interfacial pressure with a gradual decay of pressure over time. Even though R*=15 mm has the highest contact stress, the small contact area is susceptible to defects which can cause leaks. Additionally, increased curvature reduces the volume of the internal chamber, which can reduce the interfacial pressure. Meanwhile, a radius of curvature R*=25 mm for the curved contact surface 214 on the stalk 206 has high contact stress and enough contact area to be more defect tolerant while also having a larger internal volume. This prevents leaking while allowing the generation of high interfacial pressure.

Curvature of the curved contact surface 214 also impacts attachment switchability on smooth surfaces. In the activated state, attachment strength is constant around 60 kPa for the flat and three example curved contact surfaces 214 (FIG. 8D). In the deactivated state, adhesion decreases with increasing stalk curvature as the contact area between the pressure actuated membrane 209 and substrate decreases FIG. 8D. However, an increase is observed for R*=15 mm which forms negative interfacial pressure when deformed.

To further understand the release characteristics of the switchable adhesive element 203 in the deactivated (neutral) state, the attachment strength as a function of preload is evaluated. The lowest attachment strength and the smallest increase in attachment strength as preload increases occurs in the R*=25 mm contact, where the strength difference between low and high preloads is 0.8 kPa. The R*=25 mm sample of the curved contact surface 214 is curved enough to maintain low contact area without large changes in volume during the preload process, providing minimal increases in attachment strength in the deactivated state and resulting in the highest switching ratio. However, flat, R*=50 mm, and R*=15 mm samples show an increase in attachment strength as preload increases, where the difference of attachment strength between the lowest and highest preloads are 4.0 kPa, 3.5 kPa, and 43.0 kPa, respectively (FIG. 8E). Increased attachment strength under higher preload is attributed to greater contact at the interface for the flat and R*=50 mm samples. The dramatic increase in the R*=15 mm attachment strength at high preloads is attributed to the deformation of the stalk, where similar to a conventional suction cup, suction is generated due to the volume change at the interface during loading. Therefore, on a smooth flat surface stalk curvature does not impact the attachment strength which maintains around 60 kPa in the activated state, but does influence the deactivated state. Taken together, this influences the adhesion switching ratio, where a radius of curvature of R*=25 mm for the curved contact surface 214 shows the highest switching ratio due to the balance of high strength with a low release strength in the deactivated state. For this reason, a radius of curvature of R*=25 mm relied on for describing examples in the remaining sections.

Environmental factors such as substrate and liquid medium can limit the effectiveness of underwater adhesives. To evaluate the performance of the switchable adhesive element 203 on different substrates, attachment strength is measured as a function of surface roughness, substrate material, and substrate curvature. Performance in different environments is then evaluated as a function of medium type and medium viscosity. Typically, attachment strength of soft materials decrease dramatically as surface roughness increases. This is evaluated with the switchable adhesive element 203 by measuring the attachment strength on underwater surfaces molded off sandpaper with different roughness (reported in Grit). Consistent attachment strengths were found as the roughness of the surface increases (FIG. 9A). For example, attachment strength reduces from 59.7 kPa on a smooth/pristine surface (Arithmetical mean height, Sa=0.7 μm) to 50.8 kPa on the roughest 80 Grit surface (Sa=41.5 μm). This modest decrease in strength is notable as the roughness of 80 Grit is ˜×59 higher compared to the pristine surface. Overall, the curvature of the curved contact surface 214 improves conformability of the switchable adhesive element 203 to rough surfaces. Curvature of the curved contact surface 214 creates both greater contact area and a higher rate of percolated contact area, where the percolated contact area provides robust sealing. This provides reliable and consistent attachment strength over a wide range of surface roughness. Furthermore, the switchable adhesive element 203 is capable of attaching to wide range of underwater substrate materials. The attachment strength was found to be consistently around 60 kPa on plastic substrates (e.g., PMMA and epoxy), low surface energy substrates (Teflon), and metallic surfaces like brass, aluminum, and steel as shown in FIG. 9B.

Additionally, the non-linear, curved, or concaved geometry of the curved contact surface 214 allows for higher tolerance on curved substrate surfaces. Attachment strength was consistent over different value of the radius of curvature from 25 mm to 150 mm as shown in FIG. 9C. This is in contrast to notable decreases in attachment strength for switchable adhesive elements without a curved contact surface at a contact end of the stalk.

Fluid at the interface can reduce the interaction between a substrate and the pressure actuated membrane 209. To evaluate the reliability of the switchable adhesive element 203 in diverse fluids, attachment strength was evaluated in various fluid types including ion-rich fluids such as seawater simulant and organic fluids such as vegetable oil. The switchable adhesive element 203 shows uniform attachment strength of approximately 60 kPa regardless of the medium type (FIG. 9D). This includes DI water, a seawater simulant, oil, and soapy water, showing the ability to strongly attach and release in diverse fluid conditions.

Furthermore, the effect of medium viscosity on attachment strength was evaluated by modifying the viscosity of water with different concentrations of Hydroxylpropyl cellulose (HPC). Here, as HPC concentration increases, the water viscosity increases. Attachment strength stays consistent with a modest drop from 60.0 kPa to 56.6 kPa, even though viscosity increases (FIG. 9D). Taken together, the results show that the range of surfaces and medium conditions for underwater attachment is notably increased by utilizing an active membrane on a soft, stalk having a curved contact surface. This allows for control of attachment and release while maintaining the ability to reliably seal on non-ideal surfaces.

The strong, on-demand attachment and release of switchable adhesive element 203 to diverse underwater objects makes them compelling candidates for underwater attachment and precise manipulation. To support larger loads, individual switchable adhesive elements 203 can be assembled into arrays such as the system 1000 as shown in FIG. 10A. As the number of the switchable adhesive elements 203 increases from 1 to 5, the attachment force increases linearly, while the attachment strength stays constant, as shown in FIG. 10B. This result shows good scalability in attachment force.

In addition to scalability, the switchable adhesive elements 203 show reliable attachment over multiple cycles and over extended time. As seen in FIG. 10C, the normalized attachment force stays constant over 100 cycles as the switchable adhesive elements 203 are loaded to maximum capacity. Additionally, the switchable adhesive elements 203 can attach to and hold irregular-shaped objects over an extended duration.

In addition to high underwater holding capacity, the switchable adhesive elements 203 can also carefully manipulate objects underwater. This capability is demonstrated by constructing an underwater cairn, a carefully constructed pile of underwater rocks. Here the rocks have various sizes, shapes, and surface roughness. First, a rock is picked up underwater by a switchable adhesive element 203, is transported to a substrate, and is then carefully placed and released. By doing this over and over, a pile of rocks is constructed (FIG. 10F). The rocks have to be precisely placed to maintain structural stability, demonstrating the ability to strongly attach to a rough, curved rock, carefully manipulate the rock into a specific position, and then controllably release the rock. This demonstration highlights the ability of the switchable adhesive elements 203 to precisely manipulate difficult underwater objects. Furthermore, the precise control of underwater attachment and release by the switchable adhesive elements 203 enables the damage free manipulation of light and fragile objects.

By tuning the curvature at the curved contact surface 214 coupled with the pressure actuated membrane 209, contact stress can be utilized to systematically control interfacial pressure. This is especially important when a substrate has roughness, curvature, or a combination of both, where the non-linear, curved, or concaved shape of the curved contact surface 214 enhances conformal contact on large-scale curvatures and small-scale roughness. This allows the switchable adhesive element 203 to rapidly activate interfacial pressure, hold it for strong attachment, and then release it rapidly to controllable release objects on diverse surfaces and conditions. This ability is enabling for underwater manipulation tasks, as shown through example implementations of example switchable adhesive elements 203 achieving strong attachment and precise manipulation of irregular objects underwater. The different embodiments of the switchable adhesive element 203 having different radius of curvature for the curved contact surface 214 illustrate the importance of contact geometry for successful underwater attachment and release. In other embodiments, additional contact geometries such as stalk architecture and membrane shape or tuning actuation schemes may be relied to further control attachment of the switchable adhesive element 203. It also provides insight into the contract geometry of natural octopus suckers, which typically show curvature, where future studies could quantify attachment architecture to build a better understanding of the diversity of contacting shapes. Overall, the switchable adhesive element embodiments of the present disclosure can advance underwater and wet attachment which can be useful for diverse applications including robotic manipulation and healthcare.

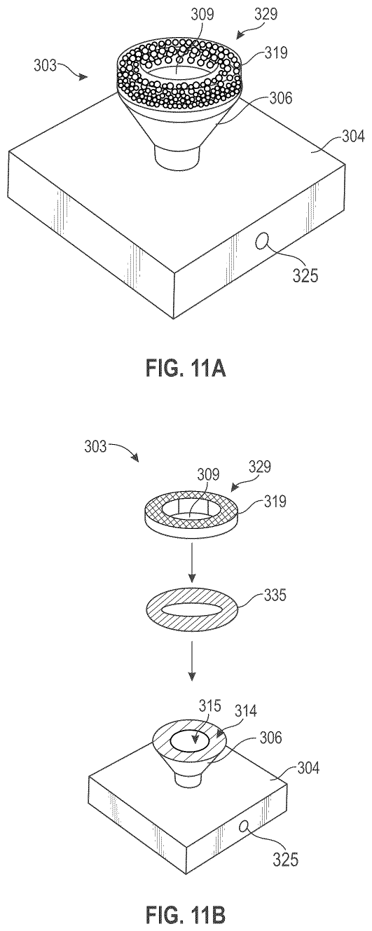

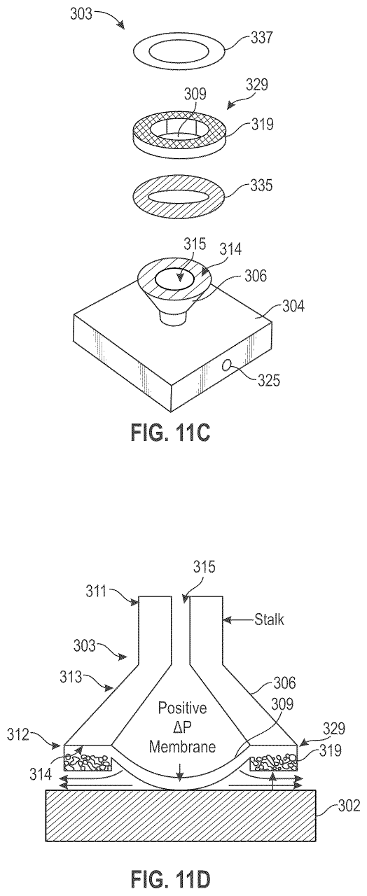

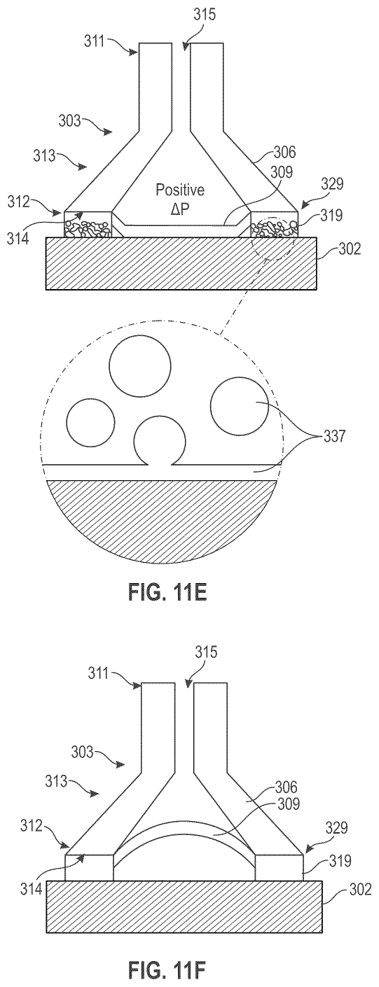

FIGS. 11A to 11F illustrate different views of another example switchable adhesive element 303 according to various aspects and embodiments of the present disclosure. In particular, FIG. 11A illustrates a perspective view of the switchable adhesive element 303 and FIGS. 11B and 11C each illustrate an exploded perspective view of the switchable adhesive element 303 according to various aspects and embodiments of the present disclosure. FIGS. 11D, 11E, and 11F illustrate different cross-sectional side views of the switchable adhesive element 303 in different example states of operation according to various aspects and embodiments of the present disclosure.

The switchable adhesive element 303 is an example alternative embodiment of at least one of the switchable adhesive elements 103, 203 described herein and illustrated in FIGS. 1A-10F. For instance, the switchable adhesive element 303 can include and implement one or more of the same or similar components, structure, attributes, features, or functions of at least one of the switchable adhesive elements 103, 203 described herein with reference to FIGS. 1A-10F.

The switchable adhesive element 303 is illustrated as a representative example of a hybrid adhesive element that can be reversibly and permanently coupled to various substrate surfaces in dry and wet environments such as underwater. The concepts described herein can be extended to use with a range of adhesive elements of different types, styles, components, and configurations, however. The switchable adhesive element 303 includes a pressure actuated porous membrane that can allow the switchable adhesive element 303 to be reversibly and permanently coupled to various types of substrate surfaces by way of pneumatic actuation and adhesion material, respectively. These features and others described in examples herein allow the switchable adhesive element 303 to be suitable for attachment to different substrate surfaces such as linear or flat, non-linear or curved, smooth, and abrasive surfaces in both dry and wet environments such as underwater.

The switchable adhesive element 303 is not drawn to any particular scale or size in the drawings. The shape, size, proportion, and other characteristics of the switchable adhesive element 303 and the components thereof can vary as compared to that shown. For example, the switchable adhesive element 303 can accommodate different component geometries or cross-sections, configurations, and locations, and other variations are within the scope of the examples described herein. Additionally, one or more of the parts or components of the switchable adhesive element 303, as illustrated in the drawings and described herein, can be omitted in some cases. The switchable adhesive element 303 can also include other parts or components that are not illustrated.

Referring to FIGS. 11A-11F, the switchable adhesive element 303 in this example includes a base 304, a compliant, silicone stalk 306 (or “stalk 306”), a soft, pneumatically or hydraulically actuated membrane 309 (or “pressure actuated membrane 309”), and a porous membrane 319, among other components. As described further below, the pressure actuated membrane 309 and the porous membrane 319 together form a soft, pneumatically or hydraulically actuated porous membrane 329 (or “pressure actuated porous membrane 329”) in the example shown.

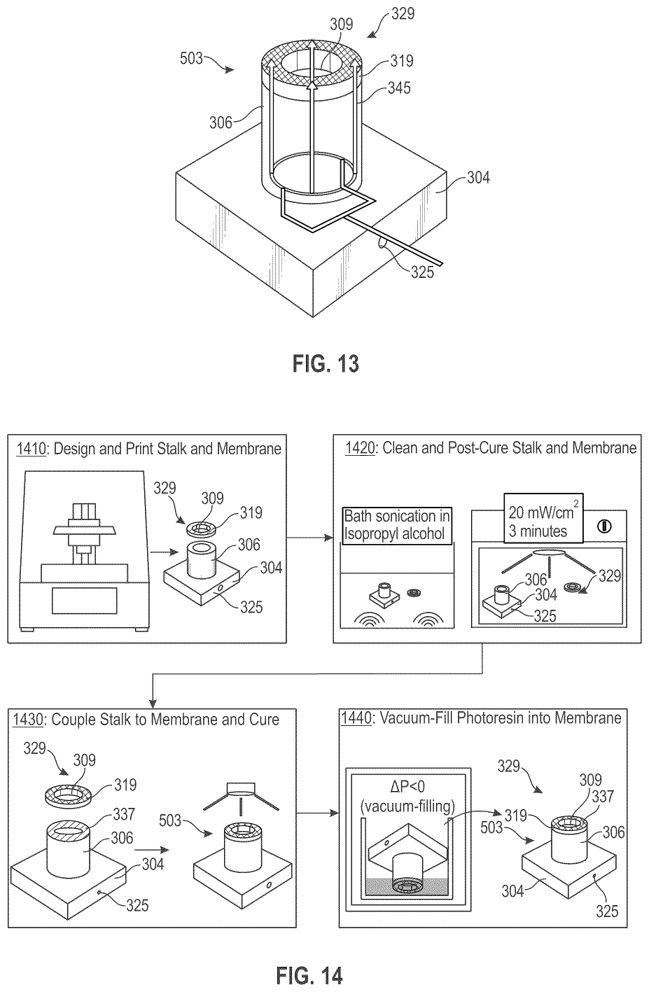

The stalk 306 extends from a support end 311 to a contact end 312. The stalk 306 includes a tapered outer surface 313 and a contact surface 314. The stalk 306 also includes a fluid passage or channel 315 (or “fluid channel 315”) such as a microfluidic channel that extends through the stalk 306 from the support end 311 to the contact end 312. The support end 311 of the stalk 306 is at least partly integrated with or otherwise coupled to the base 304 as shown in this example. The contact end 312 of the stalk 306 and the porous membrane 319 each have at least one of an annular geometry or an annular-shaped cross-section and the pressure actuated membrane 309 has at least one of a disc geometry or a disc-shaped cross-section in the example shown, although another geometry or cross-section can be relied upon for any of these components in some cases. In some examples, the tapered outer surface 313 can be omitted from the stalk 306. For instance, the stalk 306 can be formed with a cylindrical or annular geometry from the support end 311 to the contact end 312 and with a linear outer surface relative to a longitudinal axis or centerline of the stalk 306 in some cases. For example, the stalk 306 on the switchable adhesive element 303 can be formed with the same or similar cylindrical or annular geometry as that of the stalk 306 on switchable adhesive element 503 described herein with reference to FIG. 13.

The base 304 includes a fluid port and channel 325 formed in and through a side on the base 304. The fluid port and channel 325 extends from a side on the base 304 to a region within the base 304 where the fluid port and channel 325 intersects with and is in fluid communication with the fluid channel 315 formed through the stalk 306. The fluid port and channel 325 and the fluid channel 315 are in fluid communication with at least the pressure actuated membrane 309 and can be used to pneumatically or hydraulically actuate the pressure actuated membrane 309 to reversibly attach the switchable adhesive element 303 to different substrates having various types of surfaces in dry and wet environments as described in examples herein.

The contact surface 314 on the stalk 306 can be formed as a linear or flat surface in some cases or as a non-linear, curved, semi-spherical, concaved, or tapered surface in other cases. For instance, the contact surface 314 can be formed as a linear or flat surface that is the same as or similar to the contact surface on the switchable adhesive element 103 described herein with reference to FIGS. 1A-5I. In another example, the contact surface 314 can be formed as a non-linear, curved, semi-spherical, concaved, or tapered surface that is the same as or similar to the curved contact surface 214 on the switchable adhesive element 203 described herein with reference to FIGS. 6A-10F. For instance, the contact surface 314 can be formed to have the aforementioned curvature of 1/R*>0 for enhanced control of contact formation, where R* is the radius of curvature as described in examples herein. The tapered outer surface 313 on the stalk 306 in the example shown has an external stalk angle α (e.g., an external stalk angle α of approximately 15° or more), as described herein, for enhanced compliance.

The pressure actuated membrane 309 can be formed with a linear or flat geometry along its long axis in some cases or with a non-linear, curved, semi-spherical, concaved, or tapered geometry along its long axis in other cases. For instance, the pressure actuated membrane 309 can be formed with the same or similar geometry as that of the pressure actuated membrane 109 on the switchable adhesive element 103 described herein with reference to FIGS. 1A-5I. In another example, the pressure actuated membrane 309 can be formed with a non-linear, curved, semi-spherical, concaved, or tapered surface that is the same as or similar to the pressure actuated membrane 209 on the switchable adhesive element 203 described herein with reference to FIGS. 6A-10F. For instance, the pressure actuated membrane 309 can be formed to have the aforementioned radius of curvature R* for enhanced control of contact formation as described in examples herein.

The pressure actuated porous membrane 329 is coupled to the contact surface 314 on the contact end 312 of the stalk 306 in the example shown and it at least partly caps, seals, and fluidly communicates with the fluid channel 315 at the contact end 312 of the stalk 306. For instance, the pressure actuated membrane 309 portion of the pressure actuated porous membrane 329 is coupled to the contact surface 314 on the contact end 312 of the stalk 306 and it at least partly caps, seals, and fluidly communicates with the fluid channel 315 at the contact end 312 of the stalk 306. The pressure actuated porous membrane 329 can be coupled to the contact surface 314 on the contact end 312 of the stalk 306 by way of an adhesive bonding material 335 in some examples as shown in FIGS. 11B & 11C or by way of another adhesive mechanism such as epoxy resin or photoresin in other cases.

The pressure actuated porous membrane 329 can be embodied and implemented to reversibly and permanently couple the switchable adhesive element 303 to various types of substrate surfaces by way of pneumatic actuation and adhesion material, respectively, in dry and wet environments as described in examples herein. The pressure actuated membrane 309 and the porous membrane 319 can be embodied together as a single or integrated unit forming the pressure actuated porous membrane 329 in some cases and in other cases the pressure actuated membrane 309 and the porous membrane 319 can be embodied as modular or separate components that can be coupled to one another to form the pressure actuated porous membrane 329.

In some examples, the porous membrane 319 can be omitted from the pressure actuated porous membrane 329 and the pressure actuated membrane 309 can be embodied and implemented as a pressure actuated porous membrane having regions of different porosity or material density that allow it to perform reversible attachment functions and permanent attachment functions. For instance, the pressure actuated membrane 309 can be embodied and implemented as a pneumatically or hydraulically actuated porous membrane having a first porous region with a first porosity and a second porous region with a second porosity that is higher than the first porosity of the first porous region. For example, a porous region on the pressure actuated membrane 309 that interfaces with and is coupled to the contact surface 314 can have a porosity that is higher than a porosity of another region on the pressure actuated membrane 309 that interfaces with and fluidly communicates with the fluid channel 315 at the contact end 312 of the stalk 306. In one example, porous region at or near and wrapping at least partly around an outer perimeter of the pressure actuated membrane 309 that interfaces with and is coupled to the contact surface 314 can have a higher porosity or lower material density relative to that of another region on the pressure actuated membrane 309 that interfaces with and fluidly communicates with the fluid channel 315 at the contact end 312 of the stalk 306.

The switchable adhesive element 303 is illustrated as a representative example of a hybrid octopus-mussel inspired adhesive element that can be reversibly and permanently coupled to various substrate surfaces in dry and wet environments such as underwater. To reversibly couple the switchable adhesive element 303 to a substrate surface such as a substrate 302, the pressure actuated membrane 309 can be pneumatically or hydraulically actuated as shown in FIGS. 11D-11F and described in examples herein to create a suction or vacuum force within the stalk 306 that releasably attaches the pressure actuated membrane 309 to the substrate 302. To permanently couple the switchable adhesive element 303 to the substrate 302, the porous membrane 319 can be filled (e.g., via vacuum-filling) with a liquid adhesive material 337 as shown in FIG. 11C and described in examples herein. The liquid adhesive material 337 can be embodied as or otherwise include a soluble or insoluble adhesive, a resin, an epoxy, a photoresin, a glue, or another adhesive material in some cases that can be used to temporarily or permanently secure the switchable adhesive element 303 to the substrate 302 in dry and wet environments. At least a portion of the liquid adhesive material 337 can then be squeezed or extruded out of, extracted from, or otherwise released from the porous membrane 319 and deposited onto the substrate 302 as shown in FIGS. 11D-11F and described in examples herein. In some cases, some of the liquid adhesive material 337 can also form on, in, and/or around one or more components on the switchable adhesive element 303 such as the contact end 312, the tapered outer surface 313, or the contact surface 314 on the stalk 306 or the pressure actuated membrane 309 or the porous membrane 319 on the pressure actuated porous membrane 329.

Referring to FIGS. 11D-11F, just prior to and while positioning or compressing the pressure actuated membrane 309 and the porous membrane 319 of the pressure actuated porous membrane 329 against a surface on the substrate 302, positively pressurized fluid (e.g., air or another gas) can be applied to the pressure actuated membrane 309 to expel liquid such as water from the surface on substrate 302. For instance, positively pressurized air can be applied to the pressure actuated membrane 309 in part by way of the fluid channel 315 in the stalk 306 and the fluid port and channel 325 in the base 304. The reversible suction function and permanent attachment function of the switchable adhesive element 303 can be independently and selectively controlled in some examples. Upon positioning or compressing the pressure actuated porous membrane 329 against the surface on the substrate 302, the pressure actuated membrane 309 can be pneumatically or hydraulically actuated as shown in FIGS. 11E & 11F to create a suction or vacuum force within the stalk 306 that releasably attaches the switchable adhesive element 303 to the substrate 302. While being releasably attached to the substrate 302 in some cases, at least a portion of the liquid adhesive material 337 stored in the porous membrane 319 can be squeezed or extruded out of, extracted from, or otherwise released from the porous membrane 319 and deposited onto the substrate 302. After deposition of the liquid adhesive material 337 onto the substrate 302 and components of the switchable adhesive element 303 such as the contact end 312, the tapered outer surface 313, the contact surface 314, the pressure actuated membrane 309, and the porous membrane 319, the liquid adhesive material 337 can be cured (e.g., via an ultraviolet (UV) light) to permanently couple the switchable adhesive element 303 to the substrate 302.

With the application of a pneumatic or hydraulic pressure difference (ΔP), the pressure actuated membrane 309 in the pressure actuated porous membrane 329 can be actuated to behave like a sucker component on an octopus arm enabling reversible attachment and detachment from surfaces.

The porous membrane 319 in the pressure actuated porous membrane 329 and/or delivery channels on or in the stalk 306 in some cases can be used to deliver and control deposition of the liquid adhesive material 337 such as a UV-light curable permanent adhesive material to a surface the switchable adhesive element 303 is to be bonded. At least one of the pressure actuated membrane 309, the porous membrane 319, or the pressure actuated porous membrane 329 can be embodied as or otherwise include a porous polymer structure that is infused with a UV resin material in some examples. When a load is applied to the pressure actuated porous membrane 329, the porous membrane 319 gets compressed and releases the liquid adhesive material 337. For more control over the amount of the liquid adhesive material 337 released and the time of release, one or more channels can be designed in or outside the stalk 306 walls in some cases to deliver a desired amount of the liquid adhesive material 337 on-demand to a surface on the substrate 302. These channels can be used separately from or in conjunction with the pressure actuated porous membrane 329 in some examples. When the pressure actuated porous membrane 329 comes in contact with a surface on the substrate 302, the released liquid adhesive material 337 spreads at the interface of the contacted surface and at least one of the pressure actuated membrane 309, the porous membrane 319, the contact surface 314, or the tapered outer surface 313 in the example shown in FIGS. 11A-11F.

When cured by way of exposure to UV light in some cases, the liquid adhesive material 337 can become hardened, which changes its physical state form liquid to solid. This transition of state can form a strong bond between the switchable adhesive element 303 and a contacted surface. Through this mechanism, the pressure actuated porous membrane 329 allows temporary, reversible (e.g., releasable) attachment of the switchable adhesive element 303 to surfaces in a similar manner as an octopus and also allows permanent, irreversible attachment of the switchable adhesive element 303 to surfaces in a similar manner as a mussel.

The pressure actuated membrane 309 and the porous membrane 319 in the pressure actuated porous membrane 329 can be activated independently and selectively to enable unique combination of adhesive properties in various hybrid octopus-mussel-inspired adhesives described herein from strong, reversible attachment to permanent, irreversible bonding to diverse surfaces both in dry and wet conditions (e.g., underwater). The switchable adhesive element 303 and alternative embodiments thereof described herein can be employed in various examples to manipulate adhesion of and to surfaces in multiple applications including manufacturing, naval, robotics, and rehabilitation, among others.

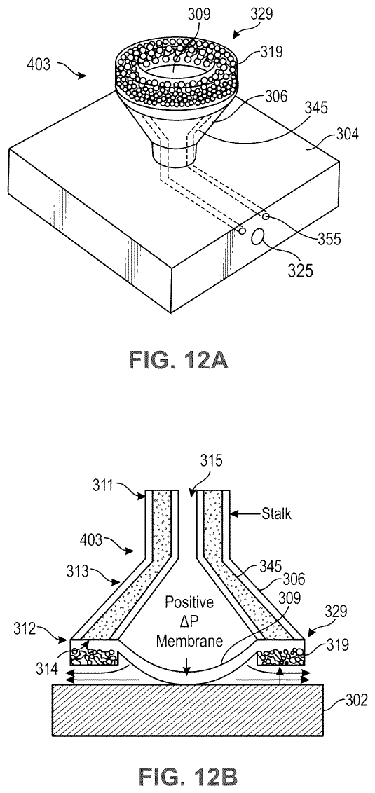

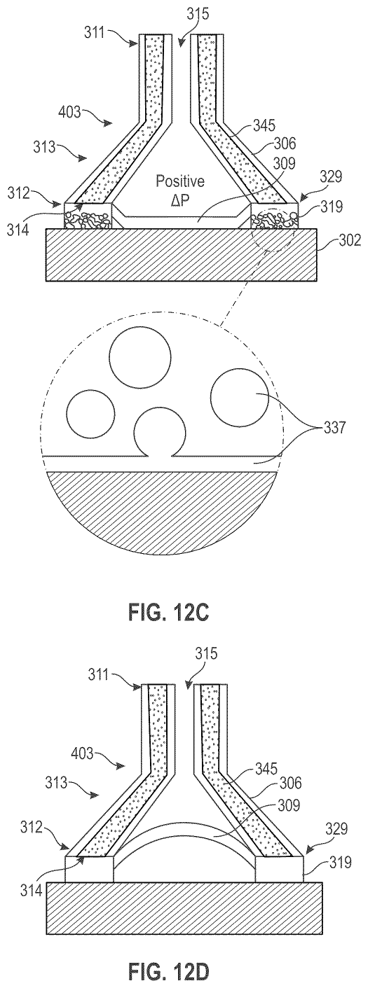

FIGS. 12A to 12D illustrate different views of another example switchable adhesive element 403 according to various aspects and embodiments of the present disclosure. In particular, FIG. 12A illustrates a perspective view of the switchable adhesive element 403 and FIGS. 12B, 12C, and 12D illustrate different cross-sectional side views of the switchable adhesive element 403 in different example states of operation according to various aspects and embodiments of the present disclosure.

The switchable adhesive element 403 is an example alternative embodiment of at least one of the switchable adhesive elements 103, 203, 303 described herein and illustrated in FIGS. 1A-11F. For instance, the switchable adhesive element 403 can include and implement one or more of the same or similar components, structure, attributes, features, or functions of at least one of the switchable adhesive elements 103, 203, 303 described herein with reference to FIGS. 1A-11F.

The switchable adhesive element 403 is illustrated as another representative example of a hybrid adhesive element that can be reversibly and permanently coupled to various substrate surfaces in dry and wet environments such as underwater. The switchable adhesive element 403 is not drawn to any particular scale or size in the drawings. The shape, size, proportion, and other characteristics of the switchable adhesive element 403 and the components thereof can vary as compared to that shown. For example, the switchable adhesive element 403 can accommodate different component geometries or cross-sections, configurations, and locations, and other variations are within the scope of the examples described herein. Additionally, one or more of the parts or components of the switchable adhesive element 403, as illustrated in the drawings and described herein, can be omitted in some cases. The switchable adhesive element 403 can also include other parts or components that are not illustrated.

Referring to FIGS. 12A-12D, the switchable adhesive element 403 in this example includes the base 304, the stalk 306, and the pressure actuated porous membrane 329, which includes the pressure actuated membrane 309 and the porous membrane 319. The stalk 306 in this embodiment further includes one or more fluid or liquid passages or channels such as a fluid or liquid passage or channel 345 (or “liquid channel 345”) formed at least partly on an outer surface of the stalk 306 or through the stalk 306 from the support end 311 to the contact end 312. The liquid channel 345 can be embodied and implemented as a microfluidic channel in some cases. In the example shown, the liquid channel 345 is in fluid communication with the pressure actuated porous membrane 329 such as in liquid flow communication with the pressure actuated porous membrane 329. For instance, the liquid channel 345 is in fluid communication with at least one of the pressure actuated membrane 309 or the porous membrane 319 at the contact end 312 of the stalk 306. The liquid channel 345 can be in direct fluid communication with one or both of the pressure actuated membrane 309 or the porous membrane 319 in some cases or in indirect fluid communication with one or both of such components in other cases. For instance, the liquid channel 345 can be in direct fluid communication with the porous membrane 319 in some cases or in indirect fluid communication with the porous membrane 319 by way of (e.g., through) at least a portion of the pressure actuated membrane 309 in other cases.

As described in examples herein, the pressure actuated porous membrane 329 can have regions of different porosity or material density in some cases that allow it to perform reversible attachment functions and permanent attachment functions. For instance, the porous membrane 319 can have one or more porous regions with a first porosity and the pressure actuated membrane 309 can have one or more porous regions with a second porosity that is lower than the first porosity of the porous regions on the porous membrane 319. In some cases, the liquid channel 345 can be in fluid communication with one or more of such relatively higher porosity regions on the porous membrane 319.

In another example, the pressure actuated membrane 309 can be embodied and implemented as a pneumatically or hydraulically actuated porous membrane having regions of different porosity or material density that allow it to perform reversible attachment functions and permanent attachment functions. For instance, the pressure actuated membrane 309 can be embodied and implemented as a pneumatically or hydraulically actuated porous membrane having a first porous region with a first porosity and a second porous region with a second porosity that is higher than the first porosity of the first porous region. For example, a porous region on the pressure actuated membrane 309 that interfaces with and is coupled to the contact surface 314 can have a porosity that is higher than a porosity of another region on the pressure actuated membrane 309 that interfaces with and fluidly communicates with the fluid channel 315 at the contact end 312 of the stalk 306. In one example, a porous region at or near and wrapping at least partly around an outer perimeter of the pressure actuated membrane 309 that interfaces with and is coupled to the contact surface 314 can have a higher porosity or material density relative to that of another region on the pressure actuated membrane 309 that interfaces with and fluidly communicates with the fluid channel 315 at the contact end 312 of the stalk 306. In this example, the liquid channel 345 can be in fluid communication with such a relatively higher porosity region on the pressure actuated membrane 309.

The base 304 on the switchable adhesive element 403 embodiment also includes a liquid port and channel 355 formed at least partly on, in, or through the base 304. The liquid port and channel 355 extends from a side on the base 304 in this example to a region within the base 304 where the liquid port and channel 355 intersects with and is in fluid communication with the liquid channel 345 formed at least partly on, in, or through the stalk 306. The liquid port and channel 355 and the liquid channel 345 are in fluid communication with at least one of the pressure actuated membrane 309 or the porous membrane 319 in the example shown in FIGS. 12A-12D.

The liquid port and channel 355 and the liquid channel 345 in some examples can be used to deliver and control deposition of the liquid adhesive material 337 onto various types of surfaces the switchable adhesive element 403 is to be bonded in dry and wet environments. For more control over the amount of the liquid adhesive material 337 released and the time of release, one or more of the liquid channel 345 or the liquid port and channel 355 can be designed in some cases to deliver a desired amount of the liquid adhesive material 337 on-demand to a surface on a substrate such as the substrate 302. The liquid channel 345 and the liquid port and channel 355 can be used separately from or in conjunction with the pressure actuated porous membrane 329 in some examples.

FIG. 13 illustrates a perspective view of another example switchable adhesive element 503 according to various aspects and embodiments of the present disclosure. The switchable adhesive element 503 is an example alternative embodiment of at least one of the switchable adhesive elements 103, 203, 303, 403 described herein and illustrated in FIGS. 1A-12D. For instance, the switchable adhesive element 503 can include and implement one or more of the same or similar components, structure, attributes, features, or functions of at least one of the switchable adhesive elements 103, 203, 303, 403 described herein with reference to FIGS. 1A-12D.

The switchable adhesive element 503 is illustrated as another representative example of a hybrid adhesive element that can be reversibly and permanently coupled to various substrate surfaces in dry and wet environments such as underwater. The switchable adhesive element 503 is not drawn to any particular scale or size in the drawings. The shape, size, proportion, and other characteristics of the switchable adhesive element 503 and the components thereof can vary as compared to that shown. For example, the switchable adhesive element 503 can accommodate different component geometries or cross-sections, configurations, and locations, and other variations are within the scope of the examples described herein. Additionally, one or more of the parts or components of the switchable adhesive element 503, as illustrated in the drawings and described herein, can be omitted in some cases. The switchable adhesive element 503 can also include other parts or components that are not illustrated.

Referring to FIG. 13, the switchable adhesive element 503 in this example includes the base 304, the stalk 306, and the pressure actuated porous membrane 329, which includes the pressure actuated membrane 309 and the porous membrane 319. The stalk 306 in this embodiment has a cylindrical or annular geometry or cross-section as shown in FIG. 13. The liquid channel 345 and the liquid port and channel 355 in this embodiment are configured differently compared to the example switchable adhesive element 403 shown in FIGS. 12A-12D to accommodate the cylindrical or annular geometry or cross-section of the stalk 306 in the example switchable adhesive element 503 shown in FIG. 13.

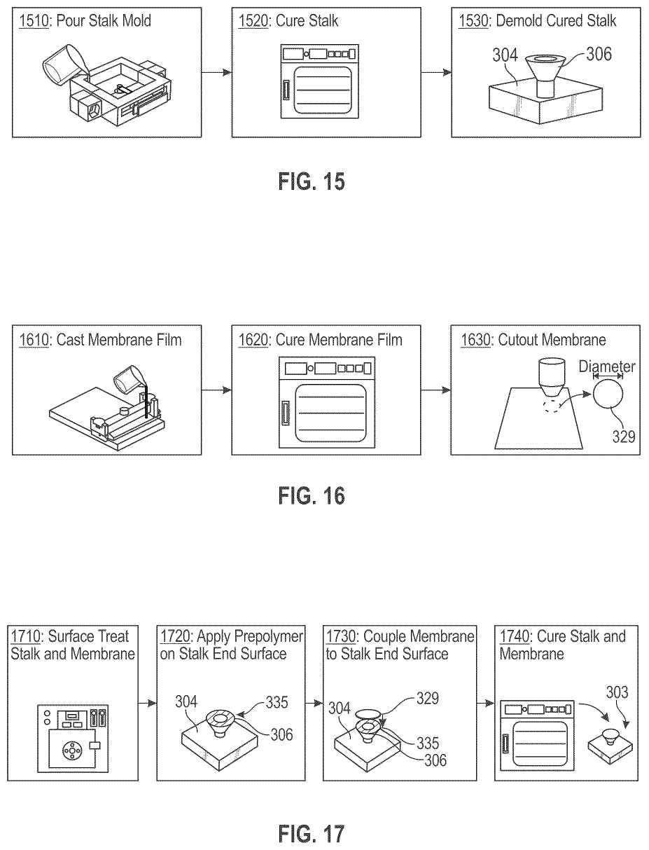

In some examples, any of the switchable adhesive elements 303, 403, 503 and respective components thereof can be fabricated by performing a three-dimensional (3D) printing process using a silicone-like 3D printing resin (e.g., Elastomer-X) and a DLP-based 3D printer as described herein with reference to method 1400 illustrated in FIG. 14. In other examples, any of the switchable adhesive elements 303, 403, 503 and corresponding components thereof can be fabricated by performing a molding and casting process using a polymer material such as polydimethylsiloxane (PDMS) as described herein with reference to methods 1500, 1600, 1700, 1800, and 1900 illustrated in FIGS. 15-19, respectively.

FIG. 14 illustrates a flow diagram of an example 3D printing fabrication method 1400 (or “method 1400”) according to various aspects and embodiments of the present disclosure. The method 1400 can be implemented in some examples to fabricate various switchable adhesive elements such as any of the switchable adhesive elements 303, 403, 503 and respective components thereof described herein with reference to FIGS. 11A-13. For instance, the method 1400 can be implemented to form the base 304 with or without one or both of the fluid port and channel 325 or the liquid port and channel 355. The method 1400 can also be implemented in this example to form the stalk 306 with or without any or all of the tapered outer surface 313, the curved contact surface 214, the fluid channel 315, or the liquid channel 345. The method 1400 can be implemented further in some cases to form the pressure actuated porous membrane 329 with the pressure actuated membrane 209 or 309 and the porous membrane 319 as a single integrated unit or as separate modular components.

At 1410, the method 1400 includes designing the base 304, the stalk 306, and the pressure actuated porous membrane 329 (e.g., the pressure actuated membrane 309 and the porous membrane 319) with porous polymer or elastomer structure in a 3D printing design application and printing these components using a 3D printer such as a DLP3D Printer (e.g., uses UV-curable photoresin). For instance, the pressure actuated membrane 309 and the porous membrane 319 are formed as a single integrated membrane in the example shown.

At 1420, the method 1400 further includes cleaning the component samples printed at 1410 in a sonication bath and then post-curing them with UV light. For instance, the component samples printed at 1410 can be cleaned in an isopropyl alcohol sonication bath and post-cured at 20 mW/cm² for 3 minutes.

At 1430, the method 1400 further includes applying a layer of photoresin such as a layer of the liquid adhesive material 337 onto at least one interfacing surface on the 3D printed stalk 306 or the pressure actuated porous membrane 329, then combining and curing these components under UV light to form the switchable adhesive element 503 in this example.

At 1440, the method 1400 in some examples can further include filling the pressure actuated porous membrane 329 with a photoresin such as the liquid adhesive material 337. For instance, in some cases the method 1400 at 1440 can further include vacuum-filling photoresin such as the liquid adhesive material 337 into the open-cell or porous structure of the porous membrane 319 on the pressure actuated porous membrane 329. In some cases, step 1440 of the method 1400 can be omitted from the method 1400.

FIG. 15 illustrates a flow diagram of an example cast and molding fabrication method 1500 (or “method 1500”) according to various aspects and embodiments of the present disclosure. The method 1500 can be implemented in some examples to fabricate various switchable adhesive elements such as any of the switchable adhesive elements 303, 403, 503 and respective components thereof described herein with reference to FIGS. 11A-13. For instance, the method 1500 can be implemented to form the base 304 with or without one or both of the fluid port and channel 325 or the liquid port and channel 355. The method 1500 can also be implemented in this example to form the stalk 306 with or without any or all of the tapered outer surface 313, the curved contact surface 214, the fluid channel 315, or the liquid channel 345.

At 1510, the method 1500 includes pouring 10:1 PDMS into a stalk mold having a desired shape or geometry for the base 304 and the stalk 306. At 1520, the method 1500 further includes curing the molded base 304 and stalk 306 formed at 1510 at 40° C. for 24 hours. At 1530, the method 1500 further includes demolding the fully cured base 304 and stalk 306 out of the mold.

FIG. 16 illustrates a flow diagram of another example cast and molding fabrication method 1600 (or “method 1600”) according to various aspects and embodiments of the present disclosure. The method 1600 can be implemented in some examples to fabricate various switchable adhesive elements such as any of the switchable adhesive elements 303, 403, 503 and respective components thereof described herein with reference to FIGS. 11A-13. For instance, the method 1600 can be implemented to form at least one of the pressure actuated membranes 209, 309 or the pressure actuated porous membrane 329. In the example shown, the method 1600 includes forming a disc-shaped embodiment of the pressure actuated porous membrane 329.

At 1610, the method 1600 includes casting 25:1 PDMS using a film applicator on a glass substrate. At 1620, the method 1600 further includes curing the PDMS cast at 1610 at 80° C. for 1 hour. At 1630, the method 1600 further includes removing the fully cured PDMS and cutting it with a circular die cutter to a desired geometry and size.

FIG. 17 illustrates a flow diagram of an example fabrication method 1700 (or “method 1700”) according to various aspects and embodiments of the present disclosure. The method 1700 can be implemented in some examples to fabricate various switchable adhesive elements such as any of the switchable adhesive elements 303, 403, 503 and respective components thereof described herein with reference to FIGS. 11A-13. For instance, the method 1700 can be implemented to couple at least one of the pressure actuated membranes 209, 309, the porous membrane 319, or the pressure actuated porous membrane 329 to the contact end 312 on the stalk 306. In the example shown, the method 1700 includes coupling a disc-shaped pressure actuated porous membrane 329 to the contact end 312 on the stalk 306 to form the switchable adhesive element 303.

At 1710, the method 1700 includes surface treating a prefabricated base, stalk, and pneumatically or hydraulically actuated porous membrane using oxygen plasma. For instance, the method 1700 can include using oxygen plasma to surface treat the base 304 and the stalk 306 formed at 1530 of the method 1500 and the pressure actuated porous membrane 329 formed at 1630 of the method 1600 described herein with reference to FIGS. 15 & 16, respectively.

At 1720, the method 1700 further includes applying a layer of the adhesive bonding material 335 such as a layer of prepolymer 10:1 PDMS onto at least one interfacing surface on the stalk 306 or the pressure actuated porous membrane 329. At 1730, the method 1700 further includes positioning or placing the pressure actuated porous membrane 329 on the layer of the adhesive bonding material 335 (e.g., PDMS) deposited on the contact surface 314 at the contact end 312 of the stalk 306. At 1740, the method 1700 further includes curing the layer of the adhesive bonding material 335 between the stalk 306 and the pressure actuated porous membrane 329 at 80° C. for 2 hours to form the switchable adhesive element 303 in the example shown.

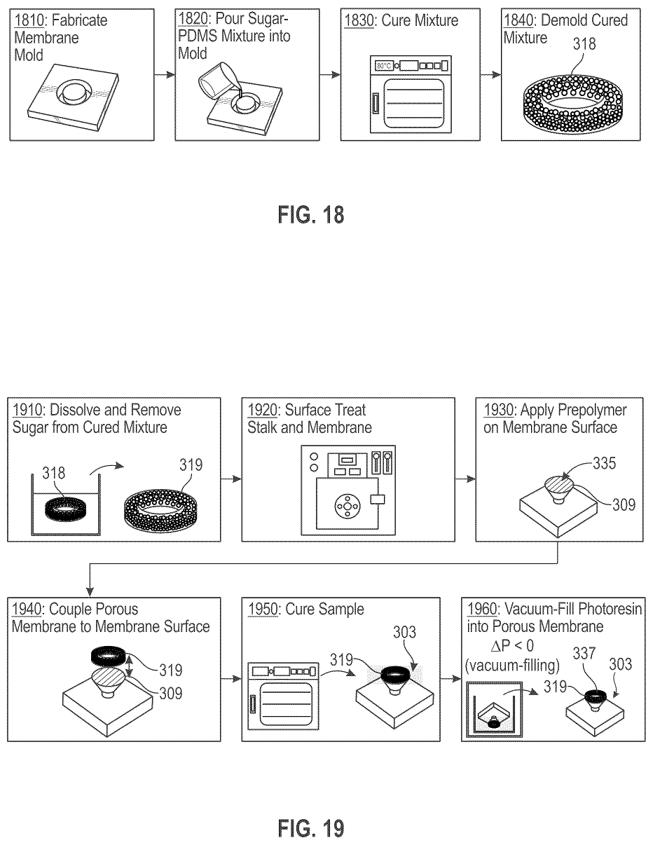

FIG. 18 illustrates a flow diagram of another example cast and molding fabrication method 1800 (or “method 1800”) according to various aspects and embodiments of the present disclosure. The method 1800 can be implemented in some examples to fabricate various switchable adhesive elements such as any of the switchable adhesive elements 303, 403, 503 and respective components thereof described herein with reference to FIGS. 11A-13. For instance, the method 1800 can be implemented to form at least one of the porous membrane 319 or the pressure actuated porous membrane 329. In the example shown, the method 1800 includes forming an annular-shaped embodiment of the porous membrane 319.

At 1810, the method 1800 includes fabricating an acrylic mold to form the pressure actuated porous membrane 329 as a porous membrane that can be filled with a UV resin. At 1820, the method 1800 further includes mixing granular sugar and 10:1 PDMS and then filling in the acrylic mold with the sugar-PDMS mixture. At 1830, the method 1800 further includes curing the sugar-PDMS mixture in the acrylic mold at 80° C. for 1 hour. At 1840, the method 1800 further includes removing a fully cured sugar-PDMS mixture 318 from the acrylic mold. In some examples, the method 1800 can further include submerging the fully cured sugar-PDMS mixture 318 in water to dissolve and remove the sugar granules from the PDMS in the fully cured sugar-PDMS mixture 318 to form the porous membrane 319.

FIG. 19 illustrates a flow diagram of another example fabrication method 1900 (or “method 1900”) according to various aspects and embodiments of the present disclosure. The method 1900 can be implemented in some examples to fabricate various switchable adhesive elements such as any of the switchable adhesive elements 303, 403, 503 and respective components thereof described herein with reference to FIGS. 11A-13. For instance, the method 1900 can be implemented to couple the porous membrane 319 to the pressure actuated membrane 309 positioned on the contact end 312 of the stalk 306. In the example shown, the method 1900 includes coupling an annular-shaped porous membrane 319 to a disc-shaped pressure actuated membrane 309 positioned on the contact end 312 of the stalk 306 to form the pressure actuated porous membrane 329 and the switchable adhesive element 303.

At 1910, the method 1900 includes creating the porous membrane 319 from a previously formed fully cured sugar-PDMS mixture such as the fully cured sugar-PDMS mixture 318 formed at 1840 in the method 1800 described herein with reference to FIG. 18. For instance, at 1910 of the method 1900 the fully cured sugar-PDMS mixture 318 can be submerged in water to dissolve and remove the sugar granules from the PDMS in the fully cured sugar-PDMS mixture 318 and create the porous membrane 319.

At 1920, the method 1900 further includes surface treating a prefabricated base, stalk, pressure actuated membrane, and porous membrane using oxygen plasma. For instance, the method 1900 can include using oxygen plasma to surface treat the base 304 and the stalk 306 formed at 1530 of the method 1500, the pressure actuated membrane 309 that can be formed in some cases at 1630 of the method 1600, and the porous membrane 319 created at 1910 of the method 1900.

At 1930, the method 1900 further includes applying a layer of the adhesive bonding material 335 such as a layer of prepolymer 10:1 PDMS onto at least one interfacing surface on the pressure actuated membrane 309 or the porous membrane 319. At 1940, the method 1900 further includes positioning or placing the porous membrane 319 on the layer of the adhesive bonding material 335 (e.g., PDMS) deposited on the pressure actuated membrane 309. At 1950, the method 1900 further includes curing the layer of the adhesive bonding material 335 between the pressure actuated membrane 309 and the porous membrane 319 at 80° C. for 2 hours to form the switchable adhesive element 303 in the example shown.

At 1960, the method 1900 in some examples can further include filling the porous membrane 319 with a photoresin such as the liquid adhesive material 337. For instance, in some cases the method 1400 at 1960 can further include vacuum-filling photoresin such as the liquid adhesive material 337 into the open-cell or porous structure of the porous membrane 319 on the pressure actuated porous membrane 329. In some cases, step 1960 of the method 1900 can be omitted from the method 1900.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt% to about 5 wt%, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’”includes “about ‘x’ to about ‘y’”.

The features, structures, or characteristics described above may be combined in one or more embodiments in any suitable manner, and the features discussed in the various embodiments are interchangeable, if possible. In the above description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,”“collinear,”“coplanar,”and other terms.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable. Further, if a component is described as there being “at least one” of said component, it is understood that this may mean “one or more” of said component. Conversely, if a component is described as there being “one or more” of said component, it is understood that this may mean “at least one” of said component.

As referenced herein in the context of quantity, the terms “a” or “an” are intended to mean “at least one” and are not intended to imply “one and only one. ” As referred to herein, the terms “include,” “includes,” and “including” are each intended to be inclusive in a manner similar to the term “comprising. ” As referenced herein, the terms “or” and “and/or” are generally intended to be inclusive, that is (i.e.), “A or B” or “A and/or B” are each intended to mean “A or B or both. ” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, fluid coupling, thermal coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A switchable adhesive element, comprising:
a compliant stalk extending from a support end to a contact end, the compliant stalk comprising a tapered outer surface and a curved contact surface at the contact end; and
a membrane coupled to the curved contact surface and capping the contact end of the compliant stalk.

2. The switchable adhesive element of claim 1, wherein the curved contact surface comprises at least one of an inwardly curved surface or a concave shaped surface.

3. The switchable adhesive element of claim 1, wherein the curved contact surface is curved with a radius of curvature between 5 mm and 100 mm.

4. The switchable adhesive element of claim 1, wherein the curved contact surface is curved with a radius of curvature of 25 mm.

5. The switchable adhesive element of claim 1, wherein the membrane comprises a curved membrane having a radius of curvature equal to a radius of curvature of the curved contact surface.

6. The switchable adhesive element of claim 1, wherein the contact end of the compliant stalk has at least one of an annular geometry or an annular-shaped cross-section.

7. The switchable adhesive element of claim 1, wherein:
the compliant stalk further comprises a fluid channel extending through the compliant stalk from the support end to the contact end;
the membrane comprises a pneumatically or hydraulically actuated membrane; and
the membrane is in communication with the fluid channel.

8. The switchable adhesive element of claim 1, wherein the membrane comprises a pneumatically or hydraulically actuated membrane that actuates in response to detection of a surface of an object by a proximity sensing element when at least one of the switchable adhesive element, the compliant stalk, or the membrane is coupled to the proximity sensing element.

9. The switchable adhesive element of claim 1, wherein a stalk angle of the tapered outer surface is about 15 degrees or more.

10. A switchable adhesive element, comprising:
a compliant stalk comprising a support end, a contact end, and a fluid channel extending through the compliant stalk from the support end to the contact end; and
a pressure actuated porous membrane coupled to the contact end of the compliant stalk and capping the fluid channel.

11. The switchable adhesive element of claim 10, wherein:
the pressure actuated porous membrane comprises a first porous region having a first porosity and a second porous region having a second porosity that is lower than the first porosity of the first porous region;
the first porous region interfaces with the contact end of the compliant stalk; and
the second porous region is in fluid communication with the fluid channel.

12. The switchable adhesive element of claim 10, wherein:
the compliant stalk further comprises a liquid channel formed at least partly on or through the compliant stalk from the support end to the contact end; and
the liquid channel is in fluid communication with the pressure actuated porous membrane.

13. The switchable adhesive element of claim 12, wherein:
the liquid channel is in fluid communication with a first porous region on the pressure actuated porous membrane;
the fluid channel is in fluid communication with a second porous region on the pressure actuated porous membrane;
the first porous region interfaces with the contact end of the compliant stalk and has a first porosity that is higher than a second porosity of the second porous region; and
the second porous region is in fluid communication with the fluid channel.

14. The switchable adhesive element of claim 10, wherein the compliant stalk further comprises a tapered outer surface having a stalk angle of about 15 degrees or more.

15. The switchable adhesive element of claim 10, wherein:
the compliant stalk further comprises a curved contact surface at the contact end; and
the pressure actuated porous membrane comprises a curved membrane having a radius of curvature equal to a radius of curvature of the curved contact surface at the contact end of the compliant stalk.

16. A switchable adhesive element, comprising:
a compliant stalk comprising a support end, a contact end, and a fluid channel extending through the compliant stalk from the support end to the contact end;
a pressure actuated membrane coupled to the contact end of the compliant stalk and capping the fluid channel; and
a porous membrane coupled to the pressure actuated membrane.

17. The switchable adhesive element of claim 16, wherein:
the compliant stalk further comprises a liquid channel formed at least partly on or through the compliant stalk from the support end to the contact end;
the liquid channel is in fluid communication with the porous membrane; and
the fluid channel is in fluid communication with the pressure actuated membrane.

18. The switchable adhesive element of claim 16, wherein:
one or both of the contact end of the compliant stalk or the porous membrane has at least one of an annular geometry or an annular-shaped cross-section; and
the pressure actuated membrane has at least one of a disc geometry or a disc-shaped cross-section.

19. The switchable adhesive element of claim 16, wherein the compliant stalk further comprises a tapered outer surface having a stalk angle of about 15 degrees or more.

20. The switchable adhesive element of claim 16, wherein:
the compliant stalk further comprises a curved contact surface at the contact end; and
the pressure actuated membrane comprises a curved membrane having a radius of curvature equal to a radius of curvature of the curved contact surface at the contact end of the compliant stalk.
